(19) United States
(12) Patent Application Publication
(10) Pub. No.: US 2011/0017770 A1
(43) Pub. Date: Jan. 27, 2011

(54) Method and apparatus for pressure equalized dispensing of a pressurized liquid in a container ("flair beverage valves")

(75) Inventors: Wilhelmus Johannes Joseph Maas, Someren (NL); Petrus Lambertus Wilhelmus Hurkmans, Someren (NL)

Correspondence Address: Kramer Levin Naftalis & Frankel LLP, 1177 Avenue of the Americas, New York, NY, 10036, US

(73) Assignee: DISPENSING TECHNOLOGIES B.V., Helmond (NL)

(21) Appl. No.: 12/800,073

(22) Filed: May 7, 2010

(30) Foreign Application Priority Data
May 7, 2009 (NL) NL 2002851

(51) Int. Cl. B67D 7/00; B65D 83/00; G01F 13/00

(52) U.S. Cl. 222/1; 222/394; 222/217; 222/363

(57) ABSTRACT

A method for dosed dispensing of a pressurized liquid is presented. In exemplary embodiments of the present invention, the method includes dispensing a liquid in a container via a dispensing opening into a dispensing space, where a difference in pressure between the container and the dispensing space is equalized in stages by using an intermediate dosing chamber. In a first stage the pressure is equalized between the container and the dosing chamber, then a quantity of the liquid is dispensed from the container into the dosing chamber, maintaining the pressure equivalence between the container and the dosing chamber by pressure communication between them. Next, the dosing chamber is isolated both as to gaseous and liquid connection from the container. Then, in a second stage the pressure is equalized between the dosing chamber and the dispensing space, and the quantity of liquid in the dosing chamber is dispensed into the dispensing space as the pressure between the dosing chamber and the dispensing space is maintained equal. The method further includes providing the liquid in a first inner container of the container, and introducing a pressure equalizing medium into a second inner container, where the first and second inner containers adjoin each other at least with a deformable and/or displaceable side. The invention also relates to a dispensing device arranged to perform, inter alia, the disclosed method. In exemplary embodiments of the present invention a dispensing device can comprise a self-contained carbonated beverage dispenser that can be stored in a consumer's refrigerator, or can, for example, be self cooling.

### CROSS-REFERENCE TO RELATED APPLICATIONS

This application claims priority to Netherlands Patent Application No. NL 2002851, filed on May 7, 2009, which is hereby incorporated herein by this reference.

### TECHNICAL FIELD

The present invention relates to dispensing technologies, and more particularly to a method and apparatus for the dispensing of a pressurized liquid in a container so as to minimize or preclude loss of any gas(es) dissolved in the liquid.

### BACKGROUND OF THE INVENTION

In the dosed dispensing of liquids in which other substances, e.g., gases, are dissolved, problems often occur as a result of the sudden release of the dissolved substances when the liquid is dispensed. For example, in the case of carbonated liquids, such as, for example, beer or soft drinks, it often happens that as a result of a decrease in pressure that occurs when the liquid flows out of the container, carbon dioxide leaves the solution and is released in gaseous form. To illustrate, It has been noted that a typical soda can has an internal pressure of 117 kPa (4° C., when canned) and 248 kPa (21° C., at room temperature), whereas standard atmospheric pressure is approximately 100 kPa. In both instances, conventional soda in a can has an overpressure relative to atmospheric pressure, it being quite significant at room temperature.

Thus, in soda water bottles, for example, gaseous carbon dioxide exists in equilibrium with the carbon dioxide dissolved in water. When the soda water bottle is opened, the carbon dioxide dissolved in it escapes out rapidly with fizz. This is because the soda bottles are sealed after adding carbon dioxide gas at high pressure (above atmospheric pressure). Because of high pressure, there is plenty of gas dissolved in water. When the soda bottle is opened, the pressure of the gas inside the bottle is considerably decreased (atmospheric pressure). Since the solubility of the gas is proportional to the pressure, the solubility decreases considerably. As a result, the gas escapes from the solution rapidly with fizz.

When the carbon dioxide gas escapes into the surrounding area, characteristic features of the carbonated drink, such as its “fizz”, “mouth feel” and perceived sweetness, for example, deteriorate.

What is needed in the art is a method and apparatus for dispensing such liquids so as to prevent or lessen these problems.

### BRIEF DESCRIPTION OF THE DRAWINGS

Various exemplary embodiments of the present invention are elucidated in the following description with reference to the following drawings, in which:

FIG. 1 shows an exemplary dispensing device according to an exemplary embodiment of the present invention, wherein the container is positioned at an angle to the horizontal;

FIG. 2 shows an alternate exemplary embodiment of the present invention, being the dispensing device of FIG. 1 provided with an additional pump at the base of the container;

FIGS. 3A and 3B are perspective detail views of each of the liquid flow and gas flow, pathways in the exemplary dispensing device of either of FIGS. 1 and 2, in the situation where a new container has been placed;

FIGS. 4A and 4B are perspective detail views of each of the liquid flow and gas flow pathways in the exemplary dispensing device of FIGS. 1 and 2, where the gas conduit is open and the liquid conduit is closed;

FIGS. 5A and 5B are perspective detail views of each of the liquid flow and gas flow, pathways in the exemplary dispensing device of either of FIGS. 1 and 2, where both the gas conduit and the liquid conduit are open;

FIGS. 6A and 6B are perspective detail views of each of the liquid flow and gas flow, pathways in the exemplary dispensing device of either of FIGS. 1 and 2, where the liquid conduit is closed and the gas conduit is open;

FIGS. 7A and 7B are perspective detail views of each of the liquid flow and gas flow, pathways in the exemplary dispensing device of either of FIGS. 1 and 2, where both the liquid conduit and the gas conduit are closed;

FIGS. 8A and 8B are perspective detail views of each of the liquid flow and gas flow, pathways in the exemplary dispensing device of either of FIGS. 1 and 2, where the air outlet conduit is open;

FIGS. 9A and 9B are perspective detail views of each of the liquid flow and gas flow, pathways in the exemplary dispensing device of either of FIGS. 1 and 2, where liquid is dispensed from the device;

FIGS. 10 and 11 respectively depict third and fourth exemplary embodiments of a dispensing device according to the present invention, where the container is positioned substantially upside down;

FIGS. 12A and 12B are perspective detail views of each of the liquid flow and gas flow, pathways in the exemplary dispensing device of either of FIGS. 10 and 11, where a new container has been placed;

FIGS. 13A and 13B are perspective detail views of each of the liquid flow and gas flow, pathways in the exemplary dispensing device of either of FIGS. 10 and 11, where the gas conduit is open and the liquid conduit is closed;

FIGS. 14A and 14B are perspective detail views each of the liquid flow and gas flow, pathways in the exemplary dispensing device of either of FIGS. 10 and 11, where both the gas conduit and the liquid conduit are open;

FIGS. 15A and 15B are perspective detail views each of the liquid flow and gas flow, pathways in the exemplary dispensing device of either of FIGS. 10 and 11, where the liquid conduit is closed and the gas conduit is open;

FIGS. 16A and 16B are perspective detail views of each of the liquid flow and gas flow, pathways in the exemplary dispensing device of either of FIGS. 10 and 11, where the air outlet conduit is open;

FIGS. 17A and 17B are perspective detail views of each of the liquid flow and gas flow, pathways in the exemplary dispensing device of either of FIGS. 10 and 11, where liquid is dispensed to the surrounding area; and

FIGS. 18-33 depict a fifth exemplary embodiment according to the present invention, implemented as a self-contained carbonated beverage dispenser that can be stored in a consumer's refrigerator.

It is noted that the patent or application file may contain at least one drawing executed in color. If that is the case, copies of this patent or patent application publication with color drawing(s) will be provided by the U.S. Patent and Trademark Office upon request and payment of the necessary fee.

### SUMMARY OF THE INVENTION

A method for dosed dispensing of a pressurized liquid is presented. In exemplary embodiments of the present invention, the method includes dispensing a liquid in a container via a dispensing opening into a dispensing space, where a difference in pressure between the container and the dispensing space is equalized in stages by using an intermediate dosing chamber. First the pressure is equalized between the container and the dosing chamber, then a quantity of the liquid is dispensed from the container into the dosing chamber, maintaining the pressure equivalence between the container and the dosing chamber by pressure communication between them. Next the dosing chamber is isolated both gaseously and liquidly from the container. In a second stage the pressure is equalized between the dosing chamber and the dispensing space, and the quantity of liquid in the dosing chamber is dispensed into the dispensing space as the pressure between the dosing chamber and the dispensing space is maintained equal. The method further includes providing the liquid in a first inner container of the container, and introducing a pressure equalizing medium into a second inner container, where the first and second inner containers adjoin each other at least with a deformable and/or displaceable side. The invention also relates to a dispensing device arranged to perform, inter alia, the disclosed method. In exemplary embodiments of the present invention a dispensing device can comprise a self-contained carbonated beverage dispenser that can be stored in a consumer's refrigerator, or can, for example, be self cooling.

### DETAILED DESCRIPTION OF THE INVENTION

In exemplary embodiments of the present invention, a method for dosed dispensing of a liquid containing a dissolved substance, such as, for example, a gas, can be performed. Such method can include dispensing a liquid from a container via a dispensing opening, wherein a difference in pressure between the container and the space in which the liquid is dispensed (the “dispensing space”) can be equalized in stages, by (i) first dispensing the liquid from the container into an inner chamber or “dosing chamber” once the pressure between the container and the dosing chamber has been equalized, and (i) second isolating the dosing chamber from the container and dispensing the liquid from the container to the dispensing space once the pressure between the dosing chamber and the dispensing space have been equalized.

In exemplary embodiments of the present invention the method can further include providing the liquid to be dispensed into a first inner container, and providing a pressure equalizing medium into a second inner container, wherein the first and second inner containers adjoin each other with a deformable and/or displaceable surface between them. The first inner container can be, for example, a flexible bag or membrane provided inside a harder container, and the second inner container can be the space between the outer surface of the bag or membrane (said bag or membrane defining the first inner container) and the inner surface of the harder container shell, such that as air is introduced in the second inner container the first inner container shrinks in volume. Such a “bag within a bag” technology is sometimes known as Flair® technology, developed by Dispensing Technologies B.V. of Helmond, The Netherlands. It is noted that there are numerous possible ways to implement a first inner container and a second inner container, all of which are understood to be useable in various exemplary embodiments of the present invention.

Contact between the equalizing medium and the liquid to be dispensed can be prevented by introducing the equalizing medium into a second inner container while the liquid to be dispensed can be, for example, provided in the first inner container. Because gas dissolved in the liquid (e.g., carbon dioxide) that leaves the solution enters the first inner container in gaseous form and remains separated from the pressure equalizing medium present in the second inner container, no mixing can take place between the equalizing medium and such gas. Thus, when the inner container with the liquid and the gas that has escaped from the solution is later cooled, all of the gas that had escaped from the solution can be re-dissolved—subject to the pressure in the second inner container—thus retaining the characteristic properties of the liquid.

In exemplary embodiments of the present invention the equalizing medium, which can be, for example, air, can, for example, thus remain separated from the liquid, which provides the advantage, both in the case of carbonated liquids as well as in the case of non-carbonated liquids (e.g., fruit drinks), of a longer shelf life and no risk of contamination.

Exemplary embodiments of the present invention offer particular advantages to liquids with a substance dissolved therein, such as, for example, carbonated liquids, and also equally apply to liquids containing, for example, dissolved N₂O, laughing gas, as well as nitrogen N₂, for example. It is noted that where carbonated liquids are given as examples herein, the present invention is understood to be equally applicable to such other liquids. Moreover, the invention is not limited to such gasified liquids, since the advantage of the increased shelf life and lack of contamination risk also applies to liquids in which there is no dissolved substance.

In exemplary embodiments of the present invention the pressure equalizing medium can, for example, cause the volume of the second inner container to increase, thereby allowing the volume of the first inner container (where the liquid to be dispensed is stored) to decrease, thus displacing the liquid for dispensing out of the first inner container, and not allowing an air gap to exist in the first inner container, thus preventing gas from leaving the liquid in the first inner container.

In exemplary embodiments of the present invention (i) the pressure of the liquid to be dispensed and (ii) the pressure in the dispensing space can be equalized in stages. This can be accomplished in (i) a first stage where first only a gas connection is made, and later a liquid connection is brought about, between the container and the dosing chamber, where the pressure in the container is equalized with the pressure in the dosing chamber by means of the gas connection, and then the liquid to be dispensed flows into the dosing chamber via the liquid connection; followed by (ii) a second stage where first a gas connection and then a liquid connection is made between the dosing chamber and the dispensing space, where the pressure in the dosing chamber is equalized with the pressure in the dispensing space via the gas connection, and the liquid now in the dosing chamber (having entered in the second part of the first stage) is then delivered to the dispensing space via the liquid connection. Thus, in the first stage liquid is displaced from the container to the dosing chamber while the pressure is maintained equal between them, and in the second stage this dosed quantity of liquid is delivered from the dosing chamber to the dispensing space while the pressure is maintained equal between them. Thus, only the dosed quantity of liquid ever contacts the dispensing space, the remaining liquid in the container being isolated therefrom via the isolation of the dosing chamber during the second stage.

In exemplary embodiments of the present invention, air can serve as an equalizing medium. Because such air is introduced into the second inner container and thus remains separated from the liquid present in the first inner container, the air extracted from the dispensing space will not mix with the liquid, and thus cannot adversely affect it (as to its characteristic properties or its shelf life, for example), as is the case in all Flair® technology. In alternate exemplary embodiments any other substance, gaseous, solid or liquid, or any combination thereof, can be used as a pressure equalizing medium, the key being to maintain an equal pressure between the two containers or chambers between which the liquid flows as it flows.

In exemplary embodiments of the present invention, an additional pressure source can, for example, be connected to the container to pressurize the second inner container. Developing a desired pressure in the second inner container can, as noted above, for example, prevent carbon dioxide from leaving the liquid in the first inner container and thus forming a gas bubble in such first inner container, which can occur, for example, when the liquid in the container is heated or moved, such as, for example, due to shaking or vibration of the container.

It is noted that such an additional pressure source can be direct or indirect. An indirect source is understood to mean a branched hose from a central pressure source of the device, such as a main pump, for example.

In exemplary embodiments of the present invention a device for dosed dispensing of a pressurized liquid from a container can be provided. The device can have, for example, a dispensing opening, a container comprising a first inner container and a second inner container, and a dosing chamber. Differences in pressure between the container and the dispensing space can be equalized in stages. This can be accomplished in (i) a first stage where first only a gas connection is made, and later a liquid connection is brought about, between the container and the dosing chamber, where the pressure in the container is equalized with the pressure in the dosing chamber by means of the gas connection, and then the liquid to be dispensed flows into the dosing chamber via the liquid connection; followed by (ii) a second stage where first a gas connection and then a liquid connection is made between the dosing chamber and the dispensing space, where the pressure in the dosing chamber is equalized with the pressure in the dispensing space via the gas connection, and the liquid now in the dosing chamber (having entered in the second part of the first stage) is then delivered to the dispensing space via the liquid connection. Thus, in the first stage liquid is displaced from the container to the dosing chamber while the pressure is maintained equal between them, and in the second stage this dosed quantity of liquid is delivered from the dosing chamber to the dispensing space while the pressure is maintained equal between them. After the first stage both the gaseous and the liquid connections between the container and the dosing chamber are closed, prior to the beginning of the second stage

In both stages the liquid and the pressure equalizing medium do not contact each other. The first time the liquid contacts the air, for example, is when it is dispensed in the second stage into the dispensing space, some time after the dosing chamber has been isolated from the remaining liquid in the container. Thus, only the dosed quantity of liquid ever contacts the dispensing space, the remaining liquid in the container being isolated therefrom via the isolation of the dosing chamber from the container at the end of the first stage.

According to an exemplary embodiment of such device, the volume of the second inner container can be enlarged by introducing the equalizing medium into it so that as said second inner container increases, the volume of the first inner container shrinks. This helps displace the liquid out of the first inner container when the liquid connection between them is open, as the first inner container progressively shrinks as the liquid in it is dispensed. This helps prevent an air gap being generated in the first inner container, and thus any dissolved gas in the liquid will remain in solution, as there is no low pressure space into which it can permeate. Because its volume is continually shrinking due to the pressure of the second inner container, the first inner container is always “full” of the liquid—no matter what quantity of the liquid is inside.

In exemplary embodiments of the present invention an exemplary device can include pressure equalizing means that operates in stages to equalize the pressure of the liquid to be dispensed with the pressure in the dispensing space. Such pressure equalizing means can include (i) a first closable gas conduit and first closable liquid conduit, both such first conduits being arranged between the container and a dosing chamber, and each individually closable with a first closing means; and (ii) a second closable gas conduit and a second closable liquid conduit, both such second conduits being arranged between the dosing chamber and the dispensing space, and each being individually closable with a second closing means, where (iii) the first and second closing means are adapted to open and close the liquid and gas passages successively, in a desired sequence.

In exemplary embodiments of the present invention such a desired sequence for opening and closing the liquid and gas passages in the first stage can include:
(a) opening the gas passage while the liquid passage is closed;
(b) opening the liquid passage so that liquid can flow out of the container to the dosing chamber;
(c) closing the liquid passage while the gas passage is still opened;
(d) closing the gas passage; and
(e) if desired, opening a gas outlet to allow any overpressure to escape to the surrounding area.

Regarding step (e), by opening the gas outlet during this step any overpressure still present between the bag of the dosing chamber and the outer wall of the dosing chamber can escape to the surrounding area.

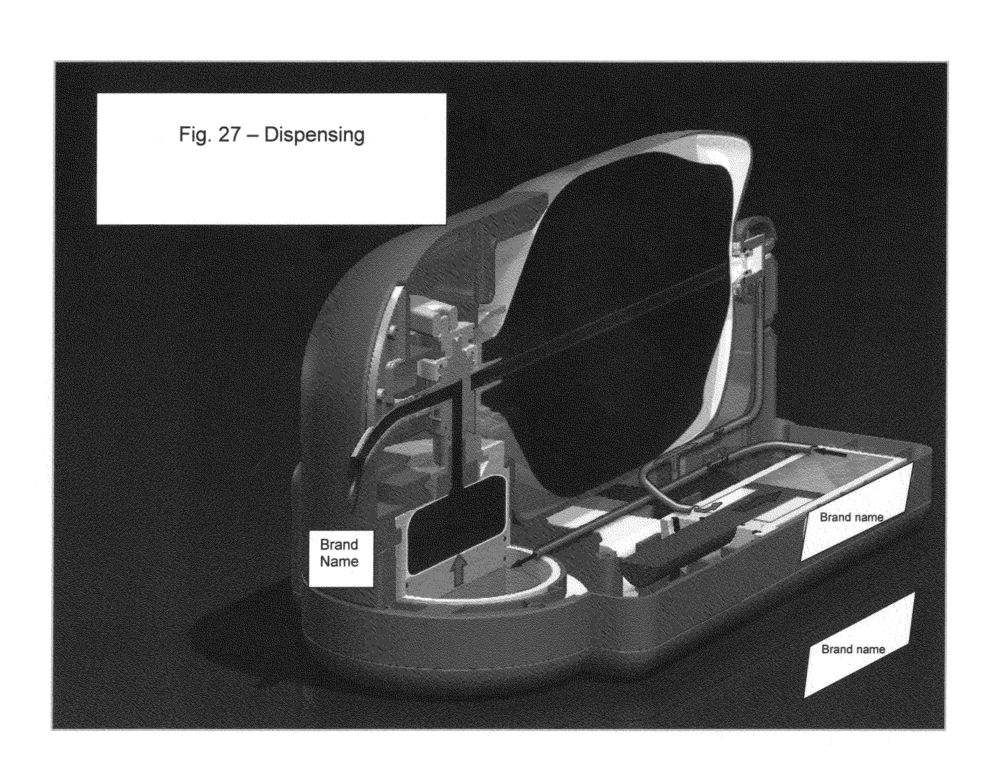

Following these operations, in the second stage, the amount of liquid now in the dosing chamber can then be dispensed (i.e., delivered to the dispensing space, generally flowing into a container held by a consumer), where the pressure in the dosing chamber is first equalized with the ambient pressure (i.e., that of the dispensing space) and maintained equal in order to prevent an under-pressure therein. In exemplary embodiments of the present invention delivery of the liquid to the dispensing space can be via gravity, or, for example, can also be via an external pressure source applied to the dosing chamber, such as is shown in FIG. 27, for example.

In exemplary embodiments of the present invention, the first and second closing means can comprise recesses arranged in a movable part, and the desired sequence of steps provided above for opening and closing the liquid and gas passages can be effected by such a movable part. Such a movable part can, for example, be integrally manufactured. The different channels for the gas and liquid feeds can thus be positioned relative to each other so as to facilitate the performance of the sequence of steps via operation of the movable part. Because in such exemplary embodiments the movable part is integrally manufactured, a correct sequence of the steps is ensured, and the part can further be made robust and reliable.

In exemplary embodiments of the present invention, an exemplary device can further include an additional pressure source connectable to the container which is adapted to pressurize the second inner container, such as pump 12 shown in FIG. 2.

In exemplary embodiments of the present invention, the dosing chamber can be removably affixed to an exemplary device, so that the dosing chamber can be exchanged for other dosing chambers having different internal volumes (with which different amounts of liquid be dispensed). The removability of the dosing chamber can also provide the option that a bag provided in the dosing chamber for receiving the liquid (as described below) can be replaced.

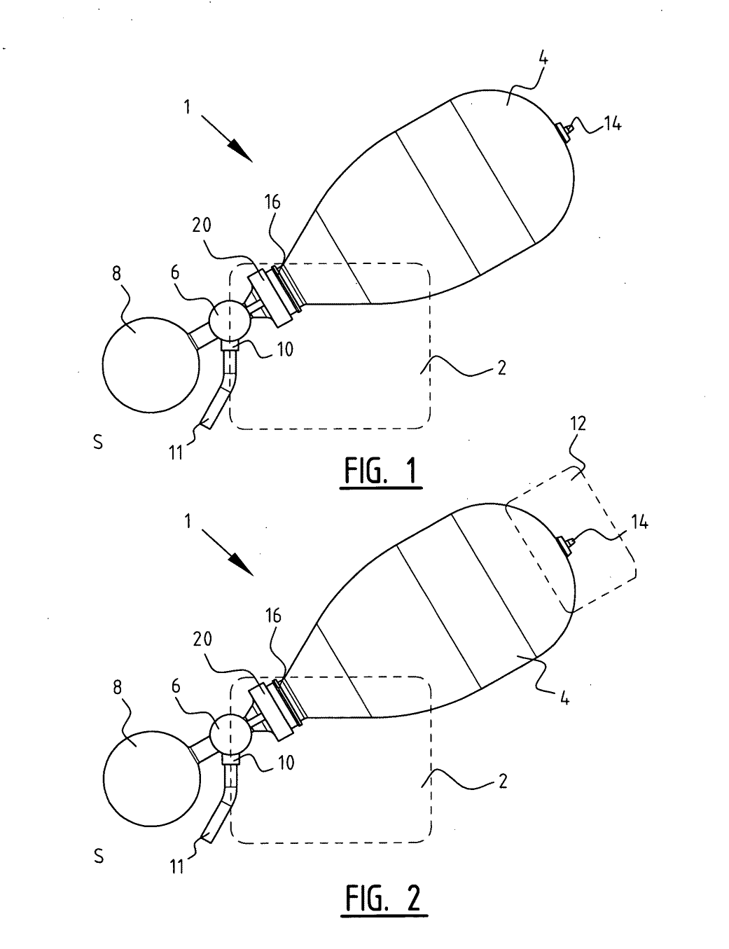

In exemplary embodiments of the present invention the container can be, for example, situated at a higher level than the dispensing opening, such as is shown in FIGS. 1 and 2 and FIGS. 10 and 11, whereby displacement of the liquid from the container to the dispensing opening can take place as a result of gravity.

In exemplary embodiments of the present invention the dosing chamber can be situated at a height between that of the container and that of the dispensing opening, so that the liquid can flow from the container to the dosing chamber due to gravity, after which a metered quantity of liquid in the dosing chamber can be further displaced under the influence of gravity to the dispensing opening.

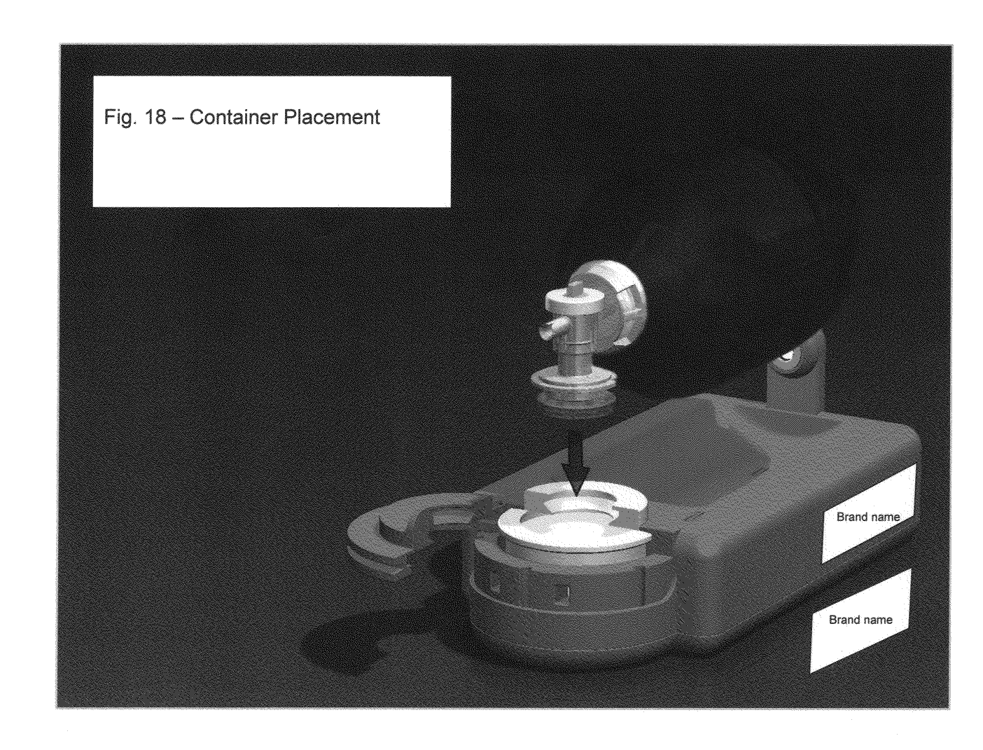

Alternatively, as shown in the exemplary embodiment of FIGS. 18-33, the dosing chamber can be at a lower height than both the container and the dispensing opening, for reasons of design choice. In such exemplary embodiments an external pressure source can be used to displace liquid from the dosing chamber to the dispensing opening.

In exemplary embodiments of the present invention devices can be provided that implement methods of dispensing a liquid as described above.

Dispensing Device with Container Positioned Upward at an Angle

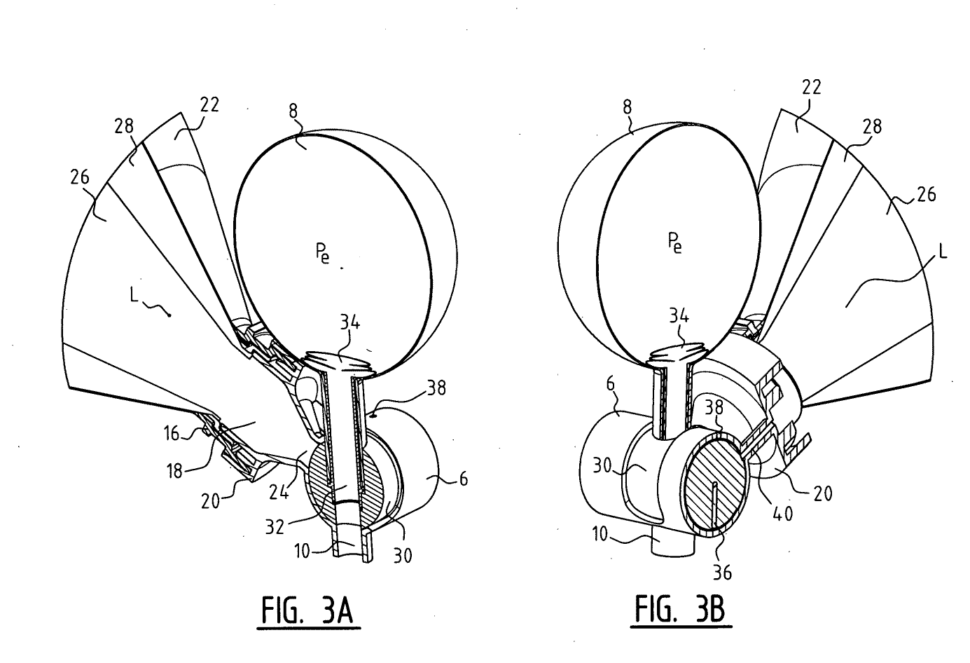

FIGS. 1 and 2 depict exemplary embodiments of an exemplary dispensing device according to the present invention. With reference thereto, the device comprises a housing 2 including a support for a container 4, which is shown as a bottle with a neck 16 and an outflow opening 18 (see FIG. 3). Dispensing device 1 comprises a connecting piece 20 onto which the neck 16 of container 4 can be fixedly snapped, clamped or screwed. Dispensing device 1 further comprises a valve housing 6 comprising a dispensing opening 10 on which an outflow conduit 11 can, for example, be arranged. Dispensing device 1 further comprises a dosing chamber 8 in which an amount of liquid L to be dispensed can be provided. Dosing chamber 8 can, for example, be replaced with dosing chambers of various other volumes, as described above.

In the exemplary embodiment shown in FIG. 2 the device further includes a pump 12 which can be connected to a valve 14 of container 4. Such a pump 12 can be used, for example, to apply pressure in a second inner container 28 of container 4 so as to pressurize liquid L present in first inner container 26. When liquid L is a carbonated liquid and container 2 is heated to some extent, such as, for example, because it is located outside a refrigerator, CO₂ gas can exit carbonated liquid L due to such heating. Supplying a counter-pressure using pump 12 via second inner container 28 can prevent carbon dioxide leaving the solution and thus a CO₂ gas bubble from being created in first inner container 26. Such counter pressure prevents the pressure in the first inner container from falling below the equilibrium pressure at whatever temperature the first inner container is at. Thus, for example, if the liquid in the first inner container is a typical soda beverage, it can have an internal pressure of 117 kPa (4° C.) and 248 kPa (21° C., at room temperature). If 11 kPa or greater is applied at 44° C., or 248 kPa or greater is applied at 21° C., any dissolved gas will not leave the liquid solution.

FIG. 3 depicts an exemplary situation in which a new container 4, with liquid L inside, can have its neck 16 fixedly clamped, screwed or snapped onto connecting piece 20 on dispensing device 1. In operation of the device, liquid L can flow under the influence of gravity through outflow opening 18 and conduit 24, through connecting piece 20, and can be stopped by closing element 30 situated in valve housing 6. In the example of FIG. 3, liquid L is situated in first inner container 26 of container 2, while a gas under a system pressure Pₛ can be situated in second inner container 28 of container 2, where Pₛ is greater than Pₑ, the ambient pressure in the dispensing space. It is noted that first inner container 26 is “interior” to second inner container 28 in the depicted exemplary device, the two being in a “bag within a bag” configuration, as described above. Various alternate configurations of the first and second inner containers can also be used, as may be desired. Dosing chamber 8 comprises an inner space which is shown at ambient pressure Pₑ. In the situation depicted in FIG. 3 gas flow through valve housing 6 is not possible.

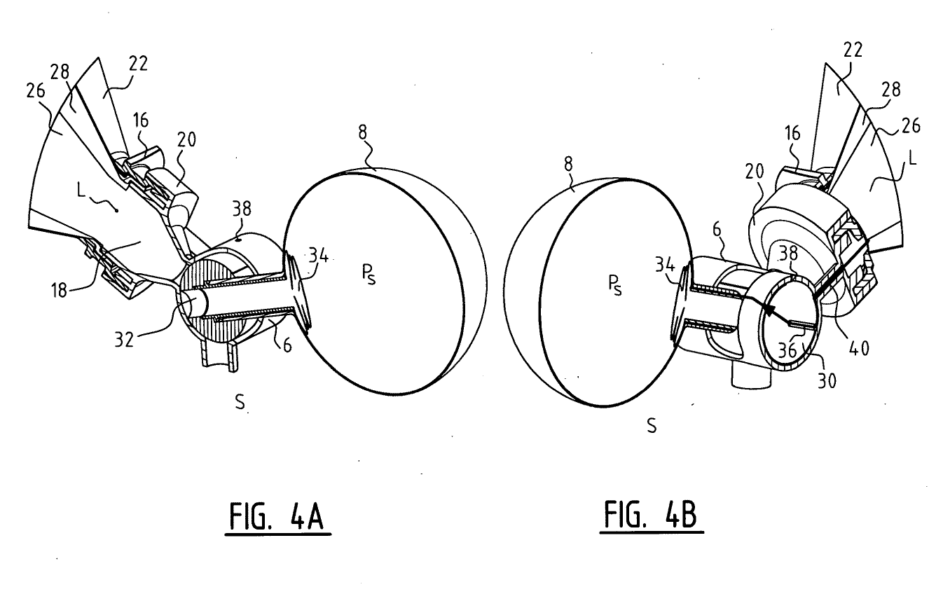

FIG. 4 depicts a situation wherein gas can flow from second inner container 28 of container 2, via a gas conduit 40 (FIG. 4B), to and through connecting piece 20, and then via gas conduit 36 in closing element 30, to the open space in dosing chamber 8. The pressure in dosing chamber 8 can thereby be equalized with system pressure Pₛ, i.e., that prevailing in second inner container 22, which is, as noted, generally higher than ambient pressure Pₑ of surrounding area S (as described above for reasons of the required counterpressure applied by the second inner container to maintain the gases in the liquid in solution).

Once the pressure in dosing chamber 8 has been equalized with system pressure Pₛ in second inner container 28, closing element 30 can be moved further relative to valve housing 6 until liquid conduit 32 (FIG. 4A), through closing element 30, connects with outflow opening 18 of container 2, and liquid can flow under the influence of gravity via conduit 32 from first inner container 26 of container 2 into bag 34. Thus, it is noted that just like the container, dosing chamber 8 has a first inner container—for liquids—and a second outer container—for gases. The first inner container is the interior of bag 34, and the second inner container is the space between the outer surface of bag 34 and the inner surface of the shell of dosing chamber 8. Thus, in exemplary embodiments of the present invention, during the first stage liquid moves form one inner bag to another, while equal pressure is maintained between the other inner bags that are also in gaseous communication. A “bag within a bag” (container) is communicably connected to another “bag within a bag” structure (dosing chamber).

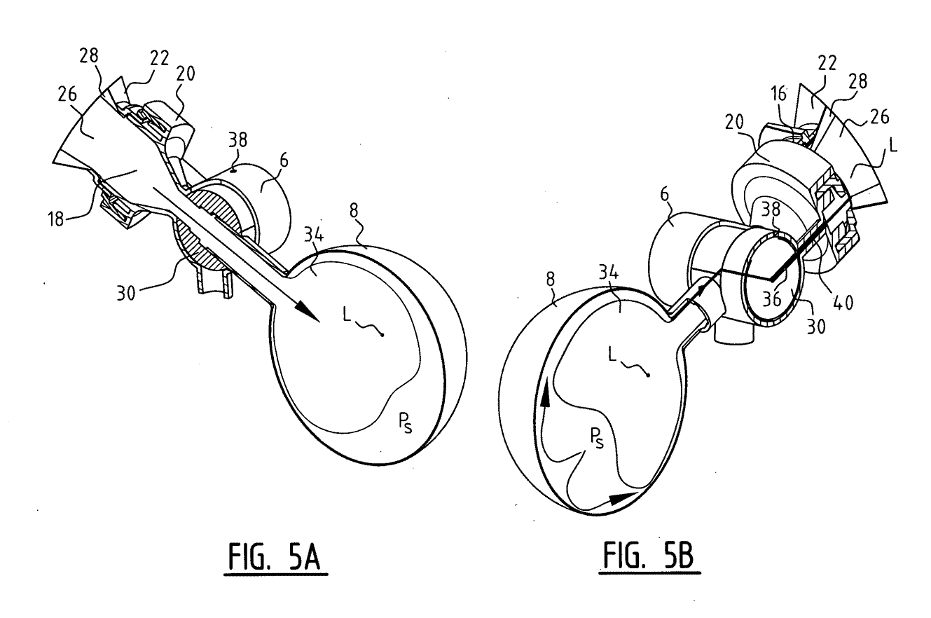

Bag 34 can, for example, be arranged in conduit 32 such that when it is filled with liquid L, it will expand inside the space of dosing chamber 8, as shown in FIG. 5. When bag 34 expands, the gas present under system pressure Pₛ in dosing chamber 8 compresses, whereby the pressure in dosing chamber 8 will increase to above Pₛ and a return flow of gas will take place to the second inner container 28 of container 2, as shown in FIG. 5B, thus keeping equal pressure between the pressure in dosing chamber and the pressure in the second inner container. It is noted that for reasons of hygiene, bag 34 can, for example, be replaceable.

Once bag 34 has taken up so much liquid L that it at least substantially fills the whole space of dosing chamber 8 (and thus essentially all of the air, or other gas, etc. used as a pressure equalizing medium, from the dosing chamber has moved back into second inner container 28), dosing chamber 8, which in the depicted exemplary embodiment also functions as a handle of dispensing device 1 (i.e., moving it controls the opening and closing of the various conduits), can be moved upward.

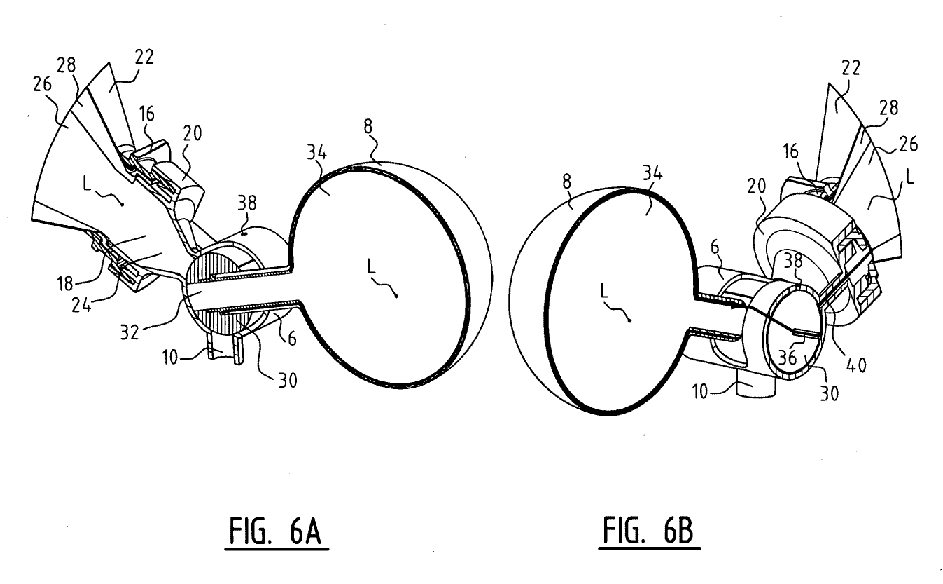

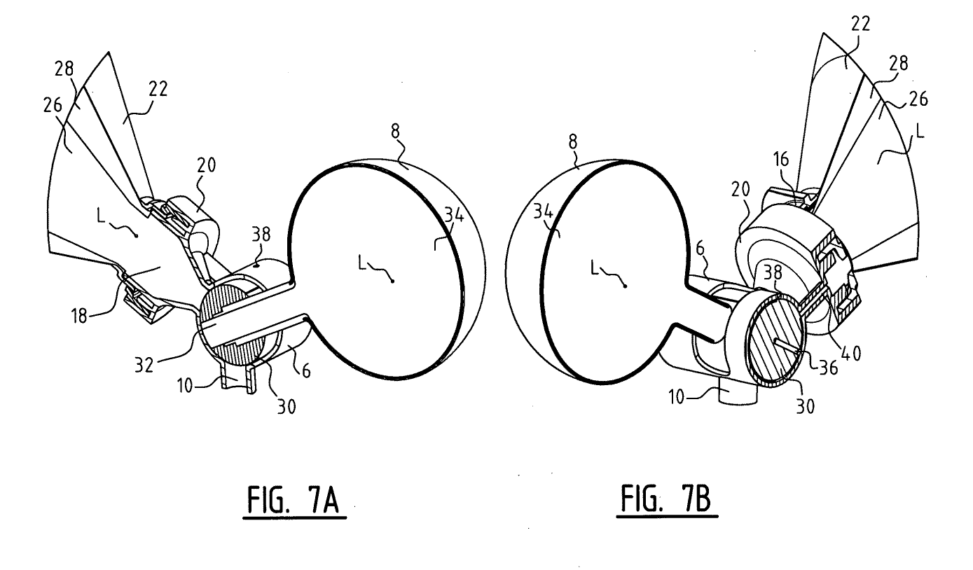

Thus, as shown in FIG. 6A, liquid conduit 32 is rotated away by closing element 30 and no longer forms a liquid connection to conduit 24 through closing piece 20 on dispensing device 1. As shown in FIG. 6B however, in this first “back upward” position of dosing device 8, the gas conduit still remains open, whereby the pressure equalization between the gas in dosing chamber 8 and the gas in second inner container 28 of container 2 can be completed, as noted. While the gas conduit between the dosing chamber and the second inner container remains open, we have the pressure equalization of the first stage. Container 8 can then, for example, be moved further upward, whereby both the liquid passage and the gas passage are closed, as shown in FIGS. 7A and 7B.

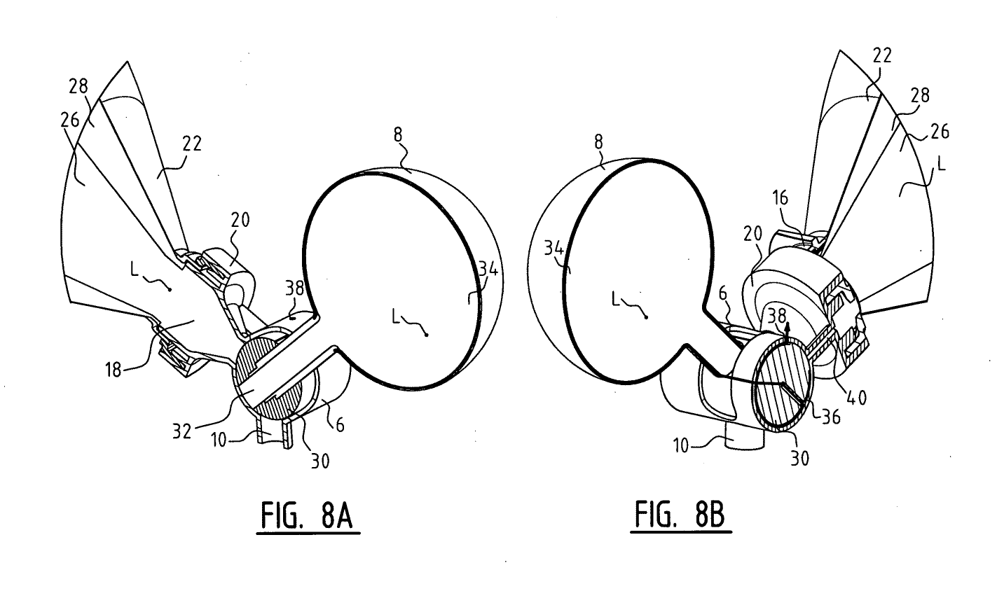

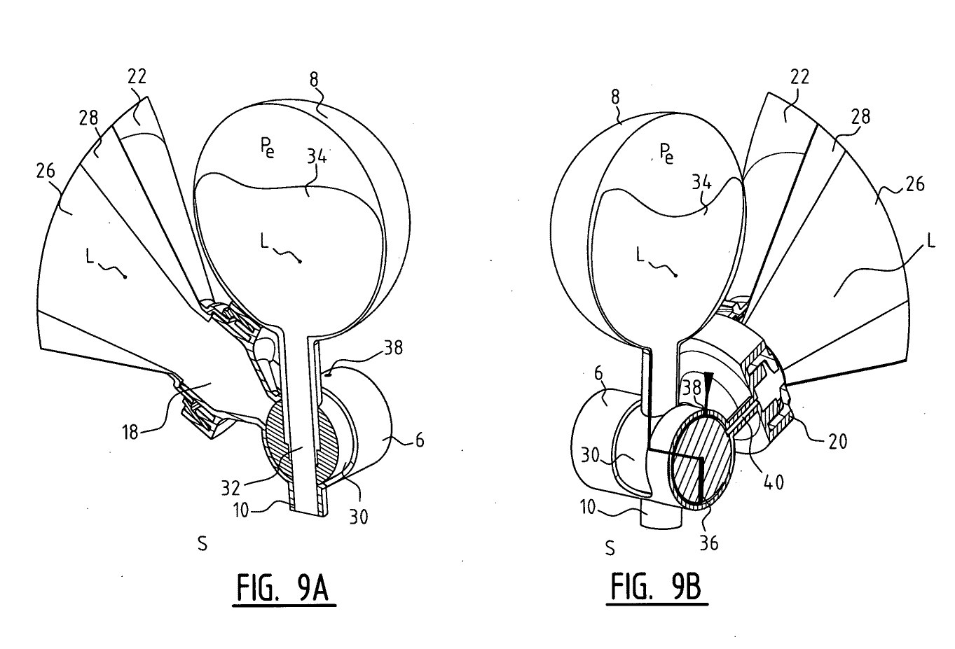

When dosing chamber 8 is moved still further upward (from the intermediate upward position of FIG. 7), a gas passage is created. Thus, any overpressure can escape to surrounding area S, so that the pressure of the gas in dosing chamber 8 can be equalized with the ambient pressure Pₑ as show in FIG. 8B. When dosing chamber 8 is moved to its uppermost position as shown in FIGS. 9A and 9B, liquid L present in bag 34 can be dispensed under the influence of gravity to dispensing area S via liquid conduit 32, which is now connected to dispensing opening 10 of valve housing 6, via an outflow conduit 11 (as shown in FIGS. 1 and 2). The liquid can be here poured into a consumer's glass, for example.

In order to prevent an underpressure in dosing chamber 8 (i.e., in the space between bag 34 and the inner surface of dosing chamber 8) as liquid L flows out of bag 34, gas can flow in this position via opening 38 and channel 36 into the void in dosing chamber 8, so that the pressure of the gas in dosing chamber 8 remains equalized with the ambient pressure Pₑ as liquid L flows out of dispensing opening 10 under the influence of gravity. This is the pressure equalization of the second stage.

Once substantially all of the liquid L that had been in bag 34 has been dispensed, dispensing device 1 will once again be in the configuration shown in FIG. 3, after which the sequence of steps described above and depicted in FIGS. 4-9 can be repeated to refill dosing chamber 8 with liquid L for ultimate further dispensing into surrounding area S.

Dispensing Device with Upside Down Container

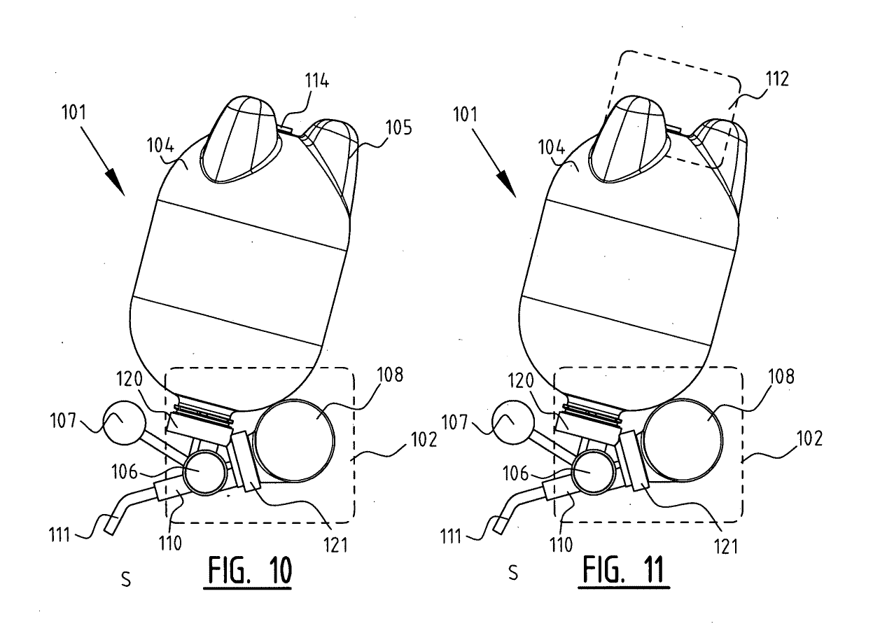

FIGS. 10 and 11 respectively depict third and fourth exemplary embodiments of a dispensing device according to the present invention, where the container is positioned substantially upside down. With reference to FIG. 10, dispensing device 101 comprises a housing 102 with support for a container 104, shown, for example, as a bottle. Container 104 is provided with feet 105 on which container 104 can be stored upright without valve 114 of container 104 being damaged. Just as in the exemplary embodiment shown in FIG. 2, an additional pump 112 can be provided if desired, this forming the fourth preferred embodiment of the present invention as shown in FIG. 11.

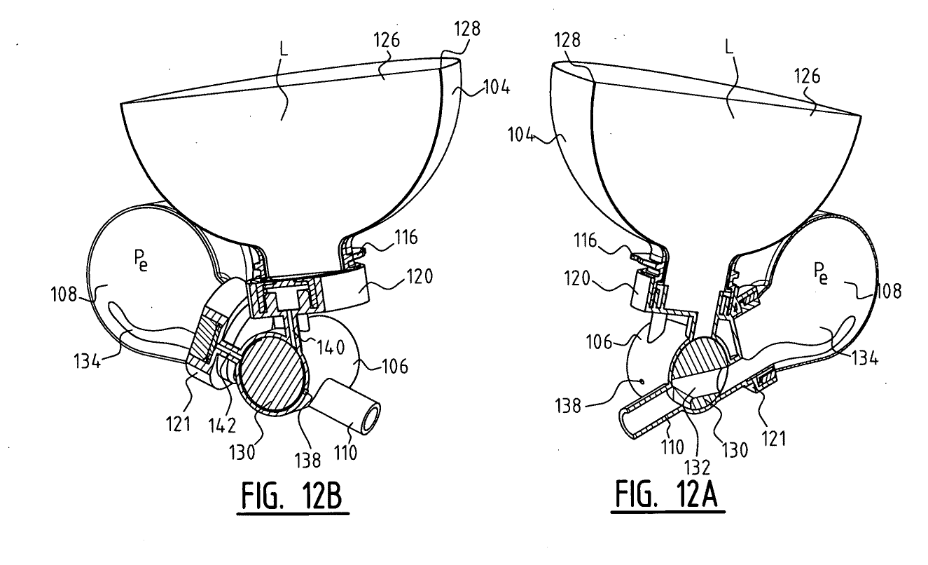

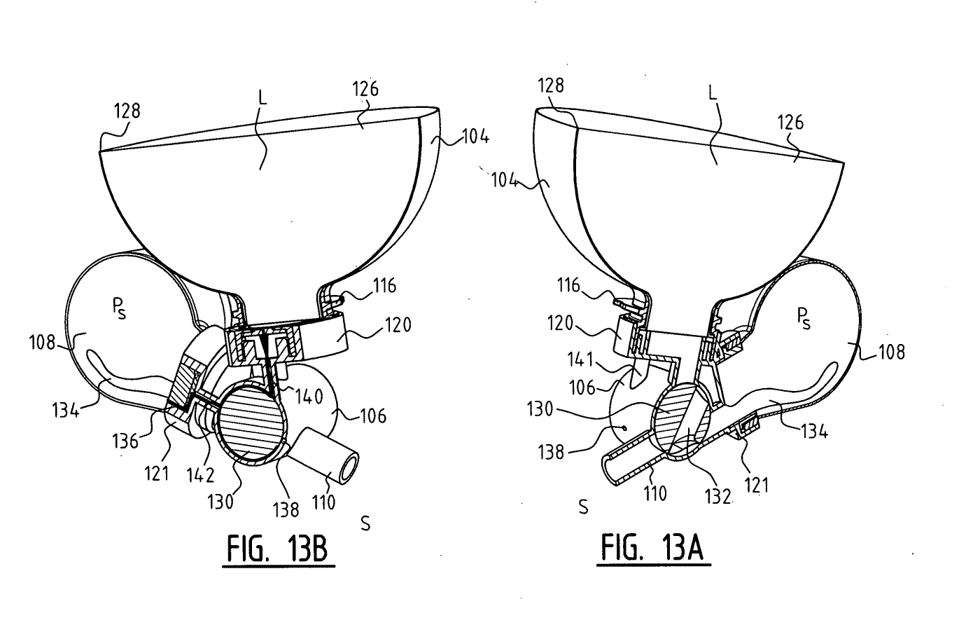

Continuing with reference to FIGS. 10 and 11, dispensing device 101 has a housing 102 in which container 104 can be placed substantially upside down. Container 104 is attached at its neck 116 (see FIG. 12) to connecting piece 120. Such attachment can be, for example, via a snap, screw or clamp fastening. Dispensing device 101 further comprises dosing chamber 108 which can, for example, be connected via a valve housing 106 to container 104. Valve housing 106 is further provided with a dispensing opening 110 on which an outflow conduit or spout 111 can, for example, be arranged. Valve housing 106 also comprises control handle 107 for operation of the valves provided in valve housing 106. Dosing chamber 108 can be, for example, removably mounted on connecting piece 121 so that the bag 134 (see FIG. 13) contained therein can be easily replaced, and, for example, dosing chamber 108 can itself be replaced with another dosing chamber 108 having a different volume. In this connection one can easily imagine times when a “small” size is desired, and others when a “large” or “super” size of beverage would be more appropriate, such as, for example, at a fraternity house in certain Colleges and Universities where the liquid is beer, for example, or, for example, on a very hot day at an outing where soft drinks are consumed in large glasses.

FIG. 12 depicts the situation in which a new container 104 has just been placed on dispensing device 101. Container 104 has a first inner container 126 in which liquid L is provided. In addition, container 104 comprises a second inner container 128 in which gas is present under a system pressure P. System pressure Pₛ is generally higher than the ambient pressure Pₑ then prevailing in dosing chamber 108.

In the exemplary embodiment of FIGS. 10-17, control handle 107 is different than dosing chamber 108, unlike the previously described exemplary embodiments. When control handle 107 (see FIG. 11) is pulled down so as to rotate closing element 130 in valve housing 106, a gas connection is created between second inner container 128 and the space inside dosing chamber 108, as shown in FIG. 13B. A first stage pressure equalization will thus take place via gas conduit 140 to and through connecting piece 120, gas conduit 136 in closing element 130 and gas conduit 142 to and through connecting piece 121, whereby the pressure in dosing chamber 108 will be brought to the system pressure Pₛ. Liquid flow to dosing chamber 108 is still not possible in this situation, as shown in FIG. 13A (liquid conduit 132 not open).

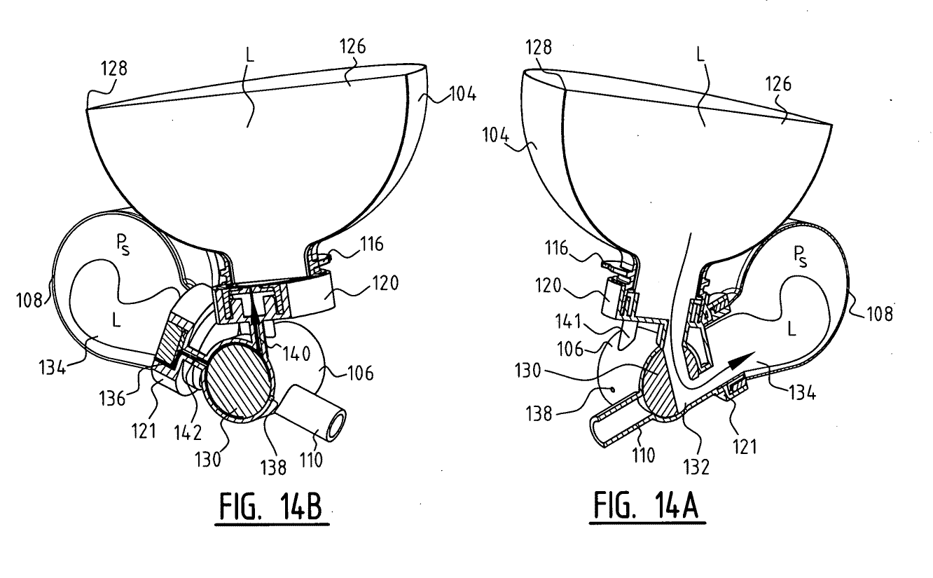

When control handle 107 is rotated further and closing element 130 simultaneously brings about a gas connection as shown in FIG. 14B, as well as a liquid connection (FIG. 14A) between container 104 and dosing chamber 108, liquid L will flow under the influence of gravity via liquid conduit 132 through closing element 130 to bag 134, as shown in FIG. 14A. As shown in FIG. 14, bag 134 will here expand and occupy an increasingly larger volume inside dosing chamber 108. Thus, pressure equalization of the first stage continues between dosing chamber 108 and second inner container 128, wherein any overpressure in dosing chamber 108 flows back to second inner container 128, as shown in FIG. 14B.

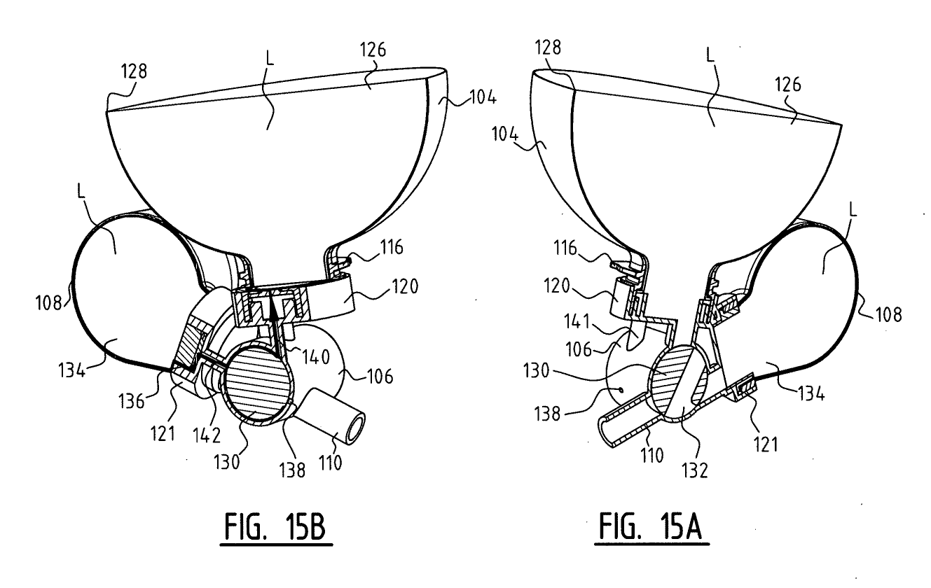

As shown in FIG. 15, a further movement of closing element 130 can close the liquid passage, yet leave the gas passage open, in analogous fashion to the situation of FIG. 6. This allows a further pressure equalization to take place between dosing chamber 108 and second inner container 128.

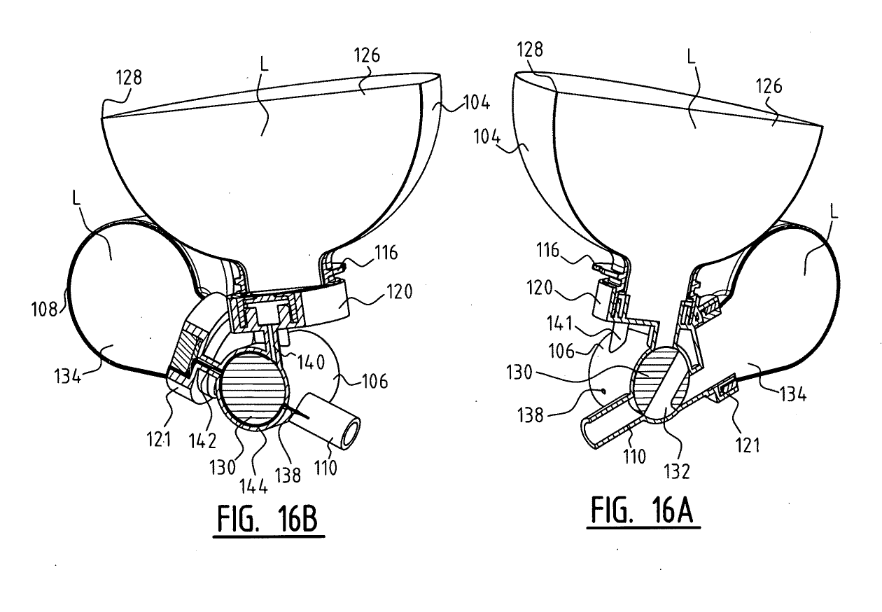

Once this pressure equalization has taken place between dosing chamber 108 and second inner container 128, the gas conduit between the dosing chamber and the second inner container is closed, thus isolating the dosing chamber therefrom. Then, if desired, after any possible overpressure has been discharged to the surrounding area S through outlet 138, as shown in FIG. 16B.

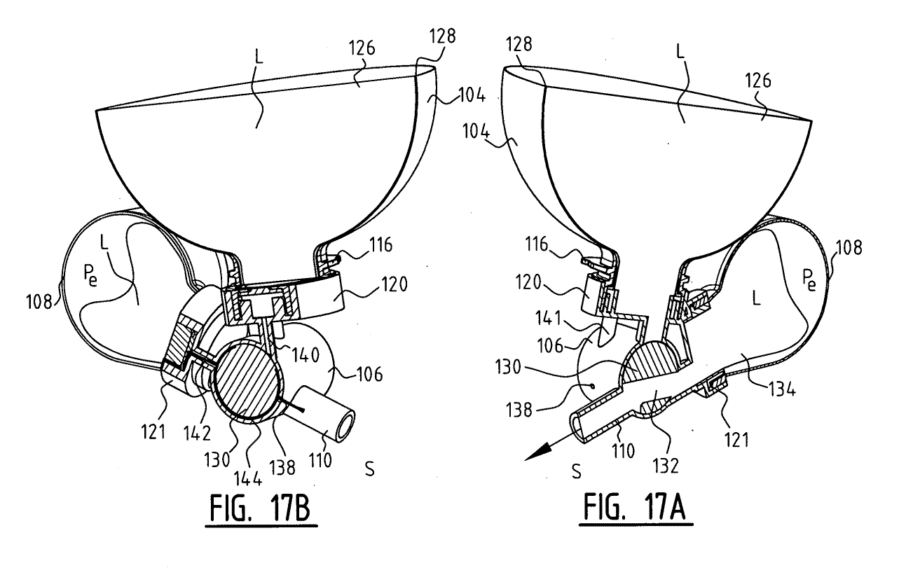

Next, for example, closing element 130 can be moved further until liquid conduit 132 provides a liquid connection between the liquid L now in bag 134 and dispensing opening 110, as shown in FIG. 17A. Because liquid L flows out of bag 134, the volume of bag 134 inside dosing chamber 108 will decrease and an underpressure will thereby be created. However, because there is a gas connection between the surrounding area S and the space inside dosing chamber 108, as shown in FIG. 17B, a pressure equalization can take place, wherein the underpressure in dosing chamber 108 is equalized with ambient pressure Pₑ, in that air from the surrounding area S flows via opening 138, gas conduit 144 and gas conduit 142 through connecting piece 121. This, once again, is the second stage pressure equalization.

Once all of liquid L that was in bag 134 has been dispensed, dispensing device 101 is once again in the situation shown in FIG. 12. A fresh quantity of liquid L can now be dispensed via dosing chamber 108 to the surrounding area S by once again performing the above described steps as depicted in FIGS. 13-17.

Dispensing Device with Horizontal Container in Self-Contained Unit

FIGS. 18 through 33 depict a self-contained unit that can be placed in a user's refrigerator, according to an exemplary embodiment of the present invention. The depicted exemplary embodiment holds a container that can be filled with a carbonated beverage, such as, for example, a cola, or for example, any other beverage. For ease of description, the depicted exemplary embodiment will be described using cola as an example of the liquid. Such an exemplary embodiment can be used, for example, to dispense fresh glasses of carbonated beverages by, for example, a consumer at home, in a “personal soda fountain.”

In the depicted exemplary embodiment of FIGS. 18-33, the cola can be dispensed according to the methods of the present invention, as described above, where the pressure equalization medium is a combination of air and water, and wherein the cola is dispensed from a container that lies horizontally in the exemplary devices, as described below. Air is used to pressurize the second inner container, but water pressure is used to equalize pressure in the dosing chamber and to dispense the cola from the dosing chamber. The air and water systems are connected via a horizontally disposed piston that is moved rearwards by the air pressure, and when it moves rearwards it transmits pressure via water lines to a vertically provided piston underneath the dosing chamber. In this regard it is noted that the pressure equalization medium can be anything capable of transmitting a generated pressure, including moving pistons with air or anything else, or any gas or liquid.

FIG. 18 depicts such a new container being placed into the exemplary device. In FIGS. 18-33 there are shown various positions on the outside of the dispensing device where a brand name of a particular beverage company could, for example, be placed. The container is a “bag in a bag” or equivalent device, and thus has a first inner container where the cola is, and a tiny air gap between the first inner container and the container outer shell; that gap is the second inner container described above.

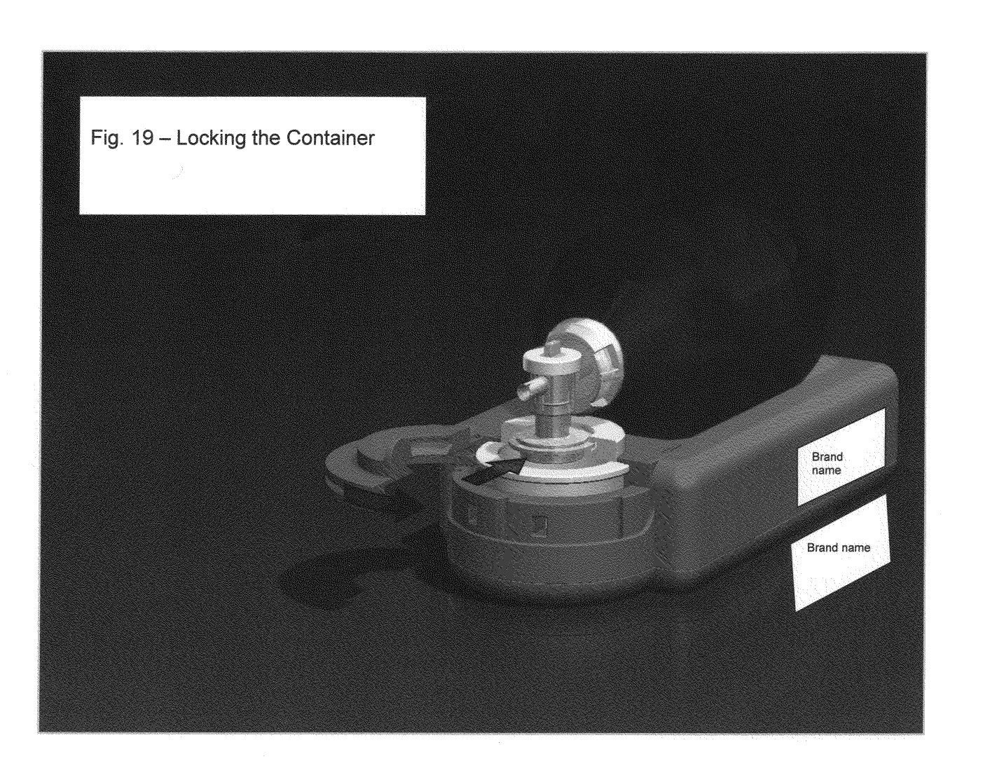

FIG. 19 depicts the new container being locked into place by means of attaching the valve to the device. The container comes with the valve housing, the valve and a bag for the dosing chamber all attached to its neck, as shown.

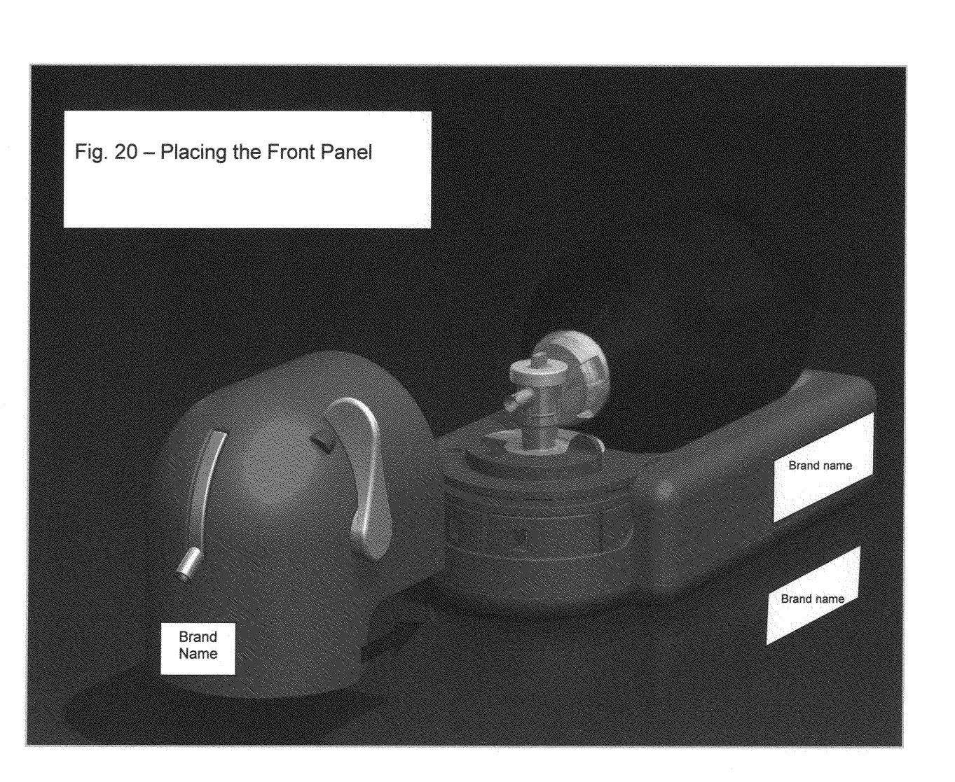

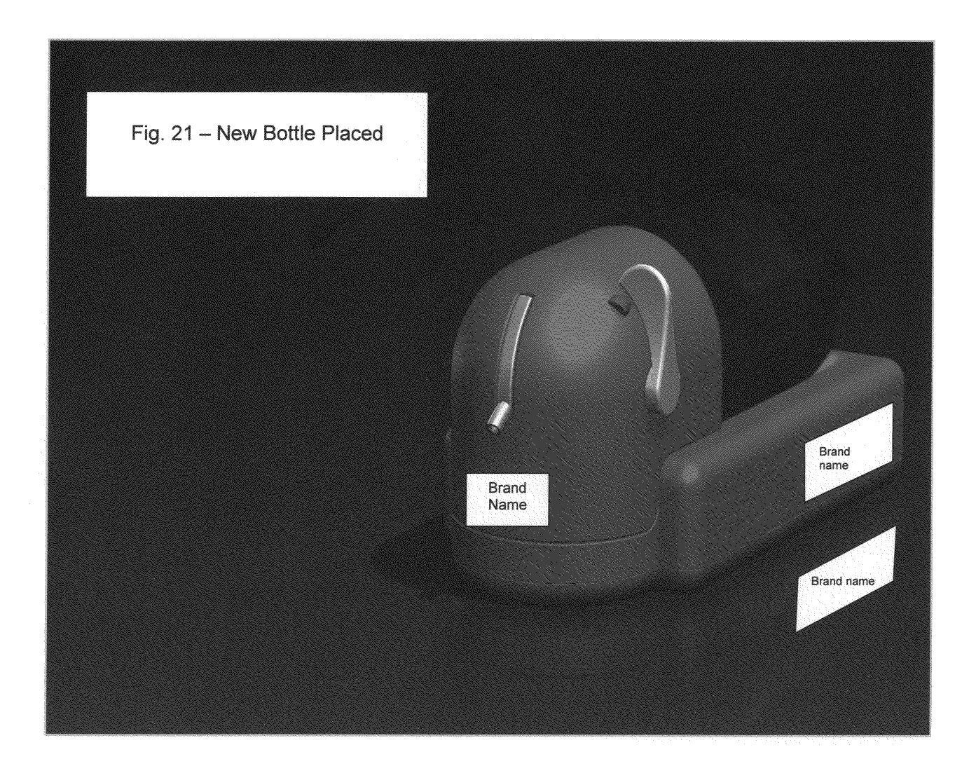

FIG. 20 depicts an exemplary front panel to the dispensing device, which contains a dispensing lever and a spout or outflow opening. FIG. 21 shows the front panel as attached to the device with the container inside.

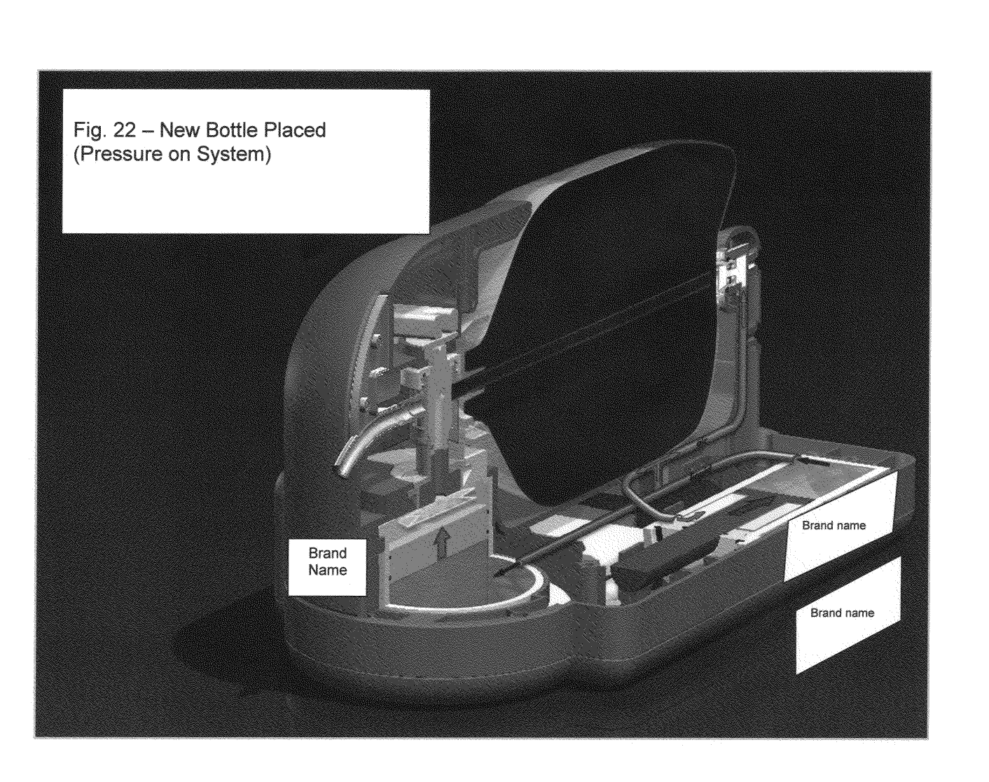

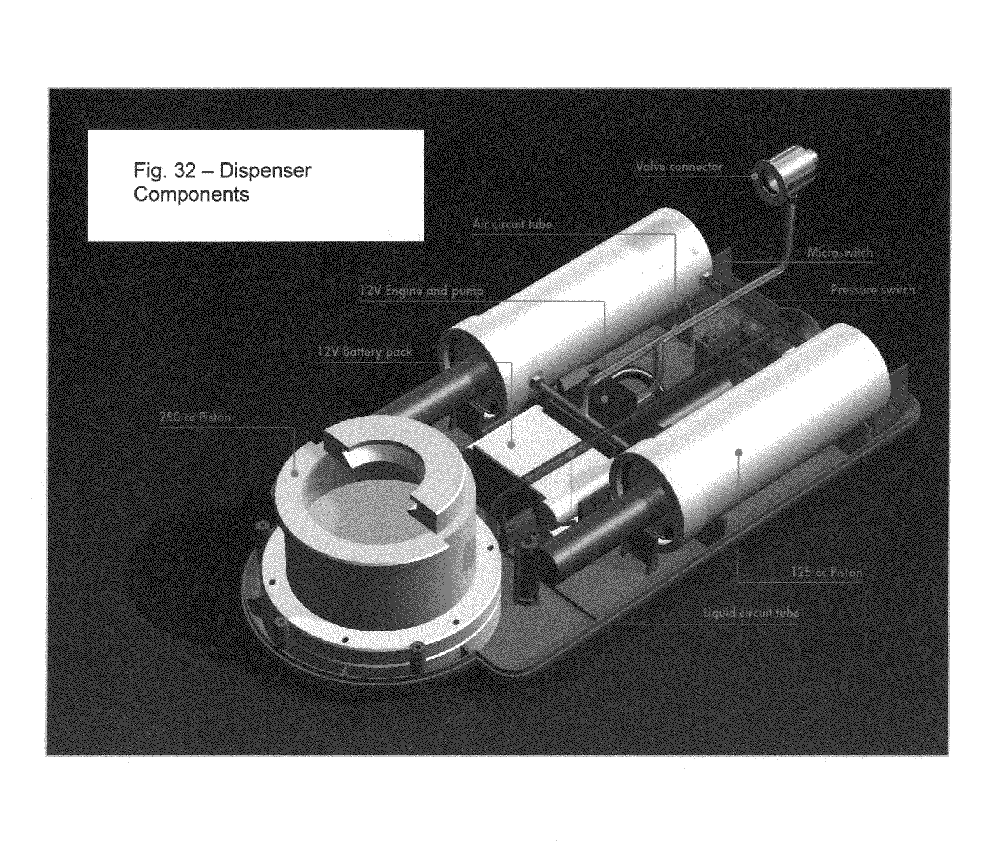

FIG. 22 depicts a situation somewhat analogous to that of FIG. 13B, where the dosing chamber's applied pressure is equalized to the applied pressure of the first inner container prior to opening the liquid conduits. Here the cola is in the container, in particular the first inner container of the container bottle, and no flow path exists yet to the dosing chamber. As noted, there are two pistons, one at the back of the device, which moves forwards and backwards, and another underneath the dosing chamber, which moves up and down. The piston underneath the dosing chamber is at its maximum vertical height, and the dosing chamber is empty. The front piston, underneath the dosing chamber, applies pressure to the bag (shown as a compressed white colored bag above the upwards pointing arrow of the front piston) as shown by the dark arrow on the front piston. This pressure is supplied by an air compressor (not shown, but see FIG. 32 “12V Engine and Pump”) that supplies air to both the second inner container and to the rearward piston via the air circuit tube. The air pressure on the rearward piston pushes it backwards, thus pushing on the water in the rearward piston chamber, as shown by the arrow. The water in the rearward piston chamber is connected via a water circuit to the front piston chamber, and it then pushes the front piston upwards, placing pressure on the dosing chamber, in particular, on the bag of the dosing chamber.

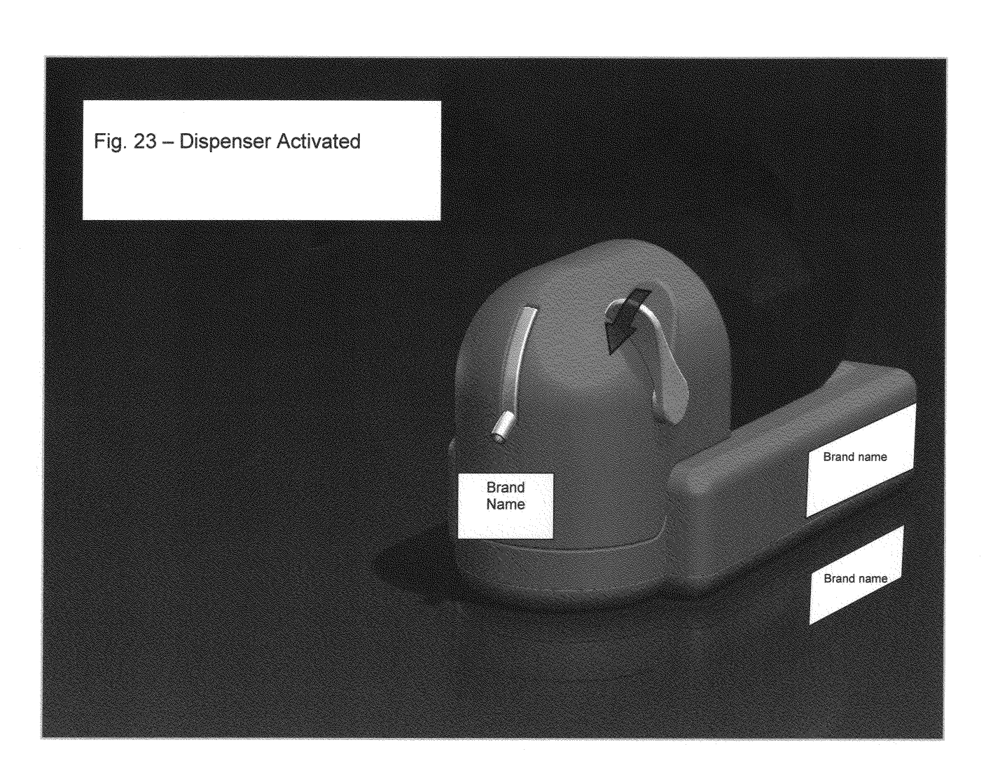

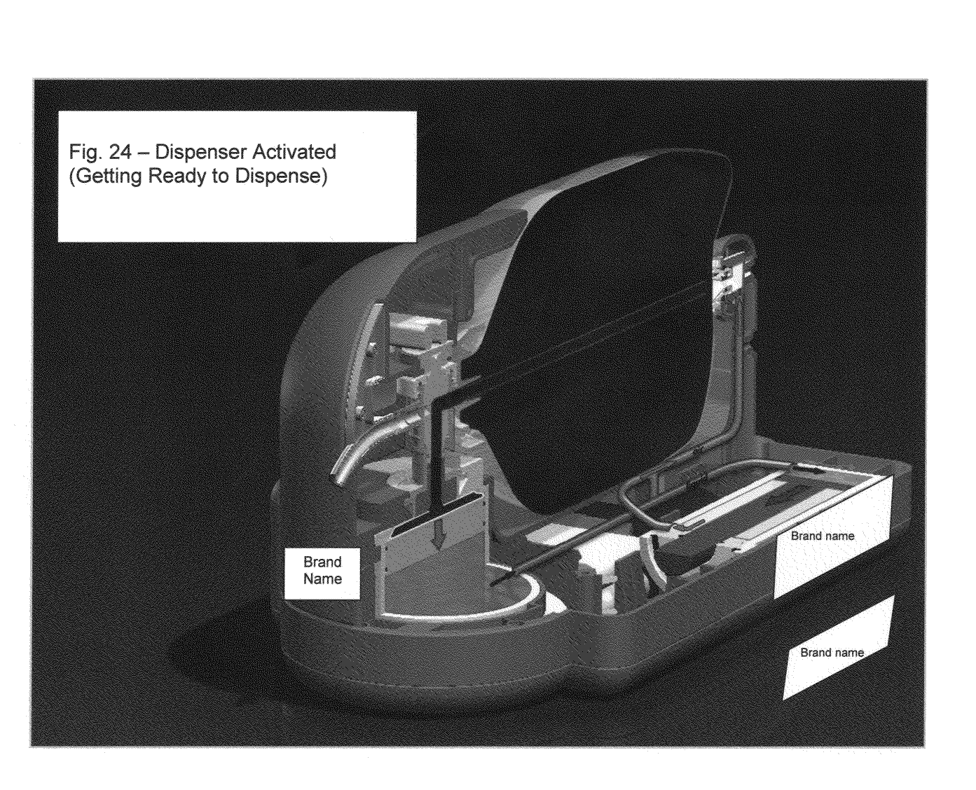

FIGS. 23 and 24 depict the situation where the dispenser has been activated by pulling down the lever, allowing the first inner container and the bag of the dosing chamber to be connected for liquid flow. Thus, under an initial impetus of air pressure supplied to the second inner container (air gap between first inner container and outer shell of container) by a pump connected to the air circuit which is connected to the valve connector at the back of the container, cola enters the bag, pushing down on the frontward piston. This pressure is analogous to the pressure exerted by bag 134 as it fills the dosing chamber 8 as shown in FIG. 5. This sends water out of the front piston chamber and through the water circuit (as shown by the arrows) to the rear piston chamber. This water then pushes the rearward piston forwards, as shown by the arrow on the piston. The rearward piston's forward movement then sends air through the air circuit tube up and into the second inner container of the bottle via the valve connector, as shown by the arrows in the air circuit tube. Thus, the second inner container and the dosing chamber are in pressure communication via the interface of the air and water circuits at the rear piston, and thus have their pressures equalized, in a first stage pressure equalization. Thus, as cola leaves the first inner container and fills the dosing chamber bag, the weight of the dosing chamber bag displaces water in the front piston chamber which pushes on the air in the rear piston chamber, so that it returns to the second inner container. It is noted that analogously to the previously described embodiments, the dosing chamber bag is filled under pressure (here supplied by front piston—previously supplied by Pₛ in dosing chamber), such that it only takes up the volume of the liquid that is in it, and thus no gas escapes from the liquid as the liquid moves form first inner container to dosing chamber bag, as an air gap is never allowed to be generated in the bag or in the first inner container.

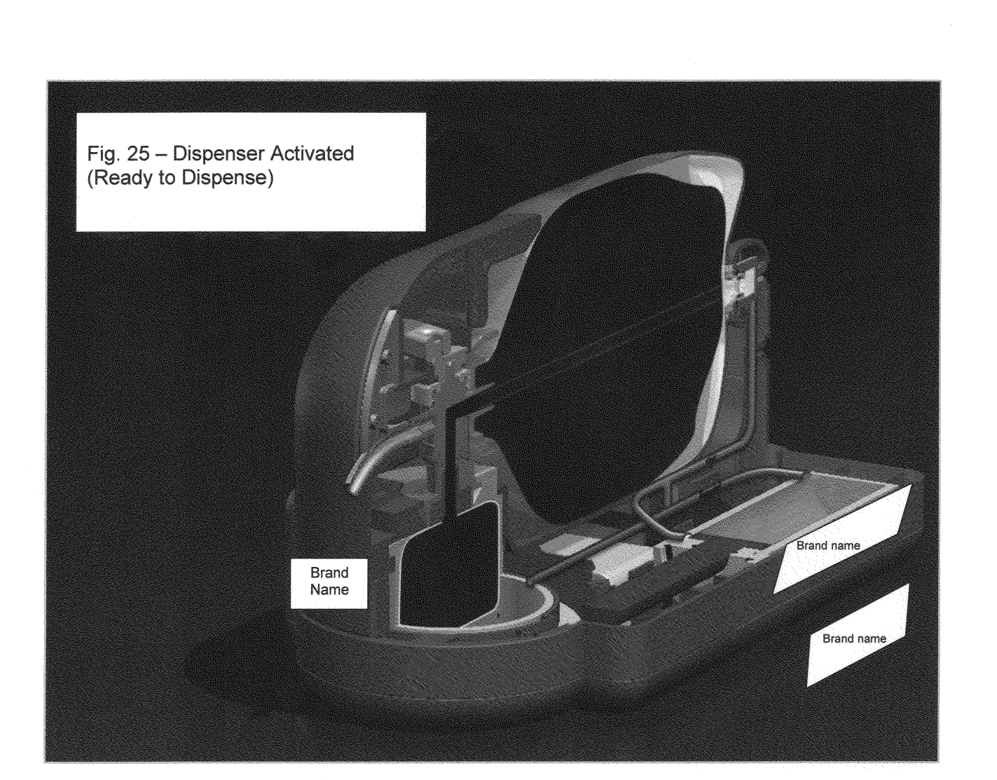

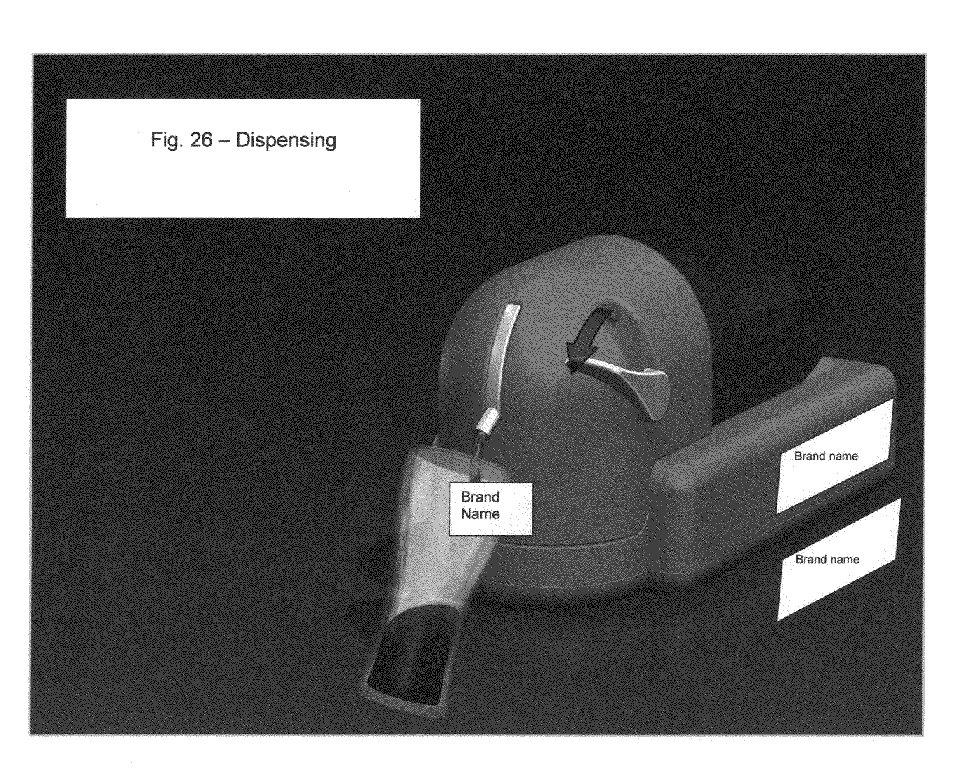

The filling of the dosing chamber completes when the bag is essentially full, and this is the situation of FIG. 25, where the now filled bag has pushed all of the water in the frontward piston chamber into the rearward piston chamber, thus pushing the rearward piston to its maximum forward extension (the term “forward” meaning towards the front of the device, in this description). The bag now being full, the device is ready to dispense its contents, as shown in FIGS. 26-27.

FIG. 26 depicts the actual dispensing of the cola, and FIG. 27 depicts how that is effected within the device. A user moving the handle causes the fluid connection between the container and the dosing chamber to be closed, and a fluid connection between the dosing chamber and the spout to be opened. Now the only liquid that can contact the outside (i.e., the dispensing space) is the quantity of cola within the dosing chamber.

As noted above, because the dosing chamber is situated below the height of the spout, gravity cannot be used to displace the cola from the dosing chamber in this exemplary embodiment. Thus, the pressure applied by the piston underneath the dosing chamber is what displaces the cola. Air is sent to the rearward piston by the air compressor (not shown, but see FIG. 32, 12V engine and pump), which, as shown in FIG. 27, pushes on the rearward piston, which displaces water so as to travel, through the water circuit, underneath the forward piston, and thus push upward against the bag in the dosing chamber to dispense the cola.

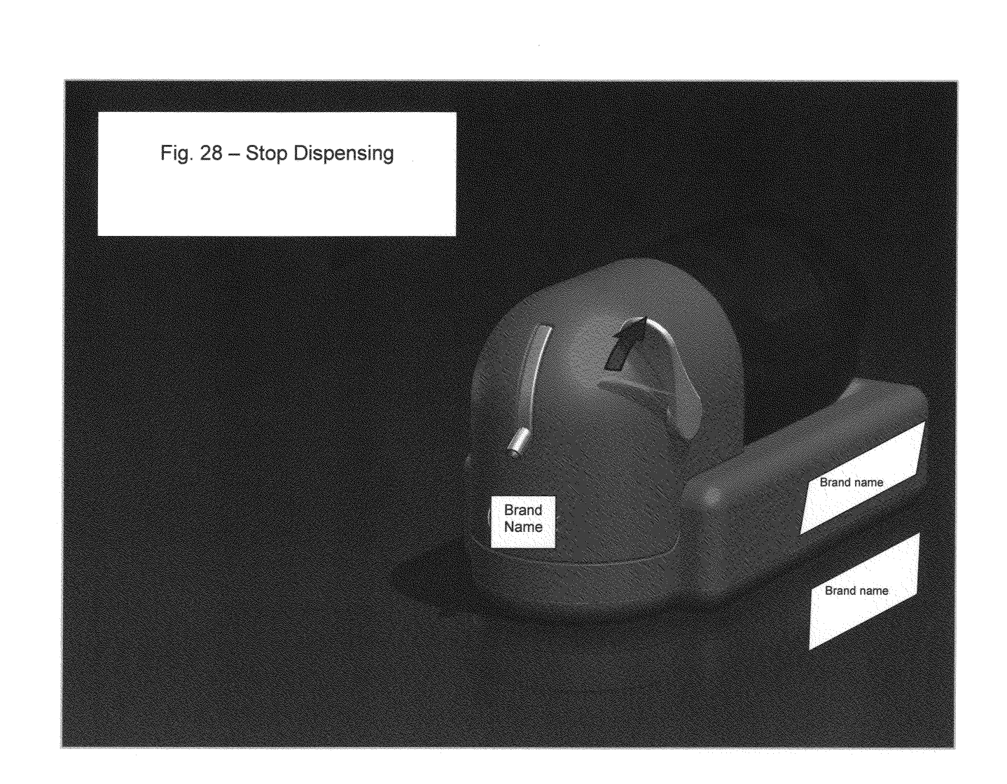

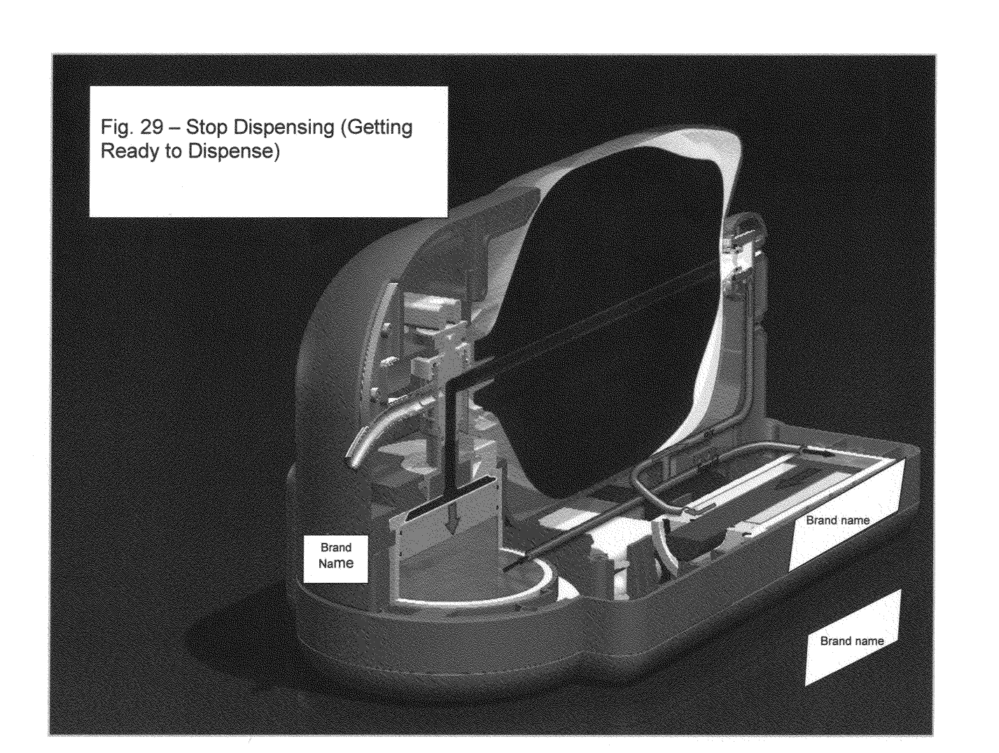

FIG. 28 illustrates stopping the dispensing by pushing the handle back up. Once this has been done, the exemplary dispensing device closes the fluid connection between the spout and the dosing chamber, and re-opens the fluid connection between the first inner container of the container and the bag of the dosing chamber, and said bag can once again begin to fill, as shown in FIG. 29. It is noted that in FIG. 29, due to the front piston which is in pressure communication with the air in the second inner container (via the rear piston interface of the air and water circuits), the pressure is equalized between the second inner container and the dosing chamber bag.

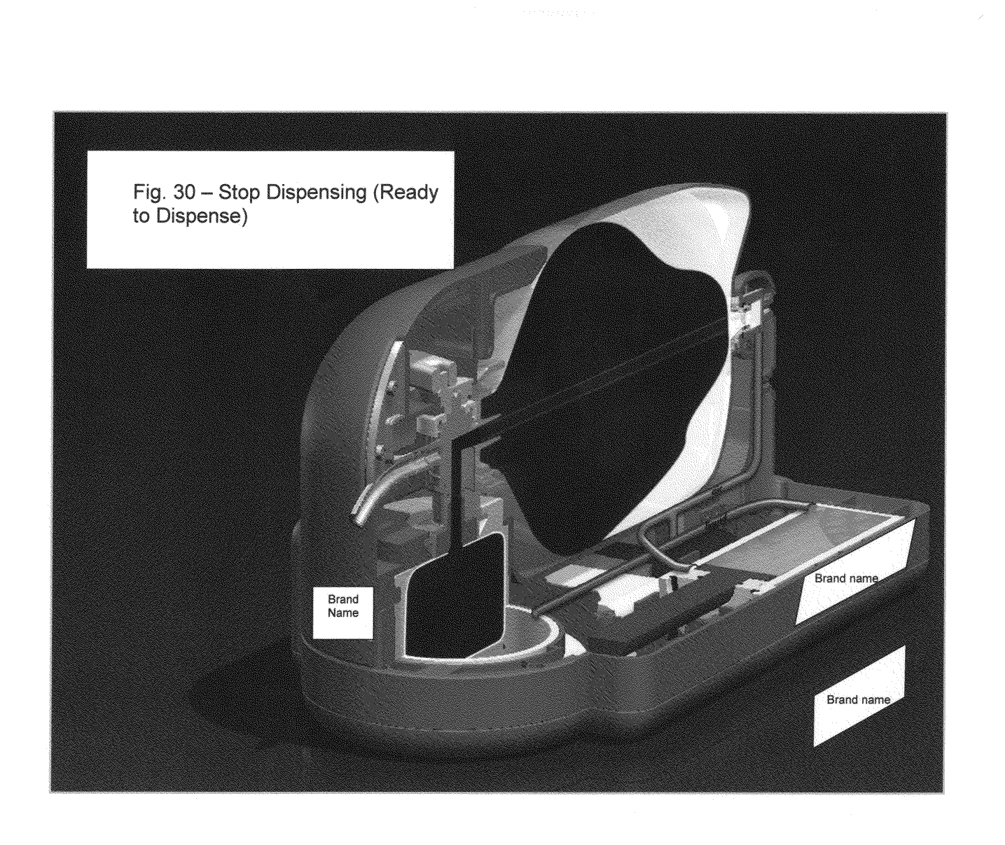

Thus, as shown in FIG. 29, the system is once again ready to dispense, and the processes shown in FIGS. 24-27 can repeat. FIG. 29 is thus identical to FIG. 24, and FIG. 30 identical to FIG. 25.

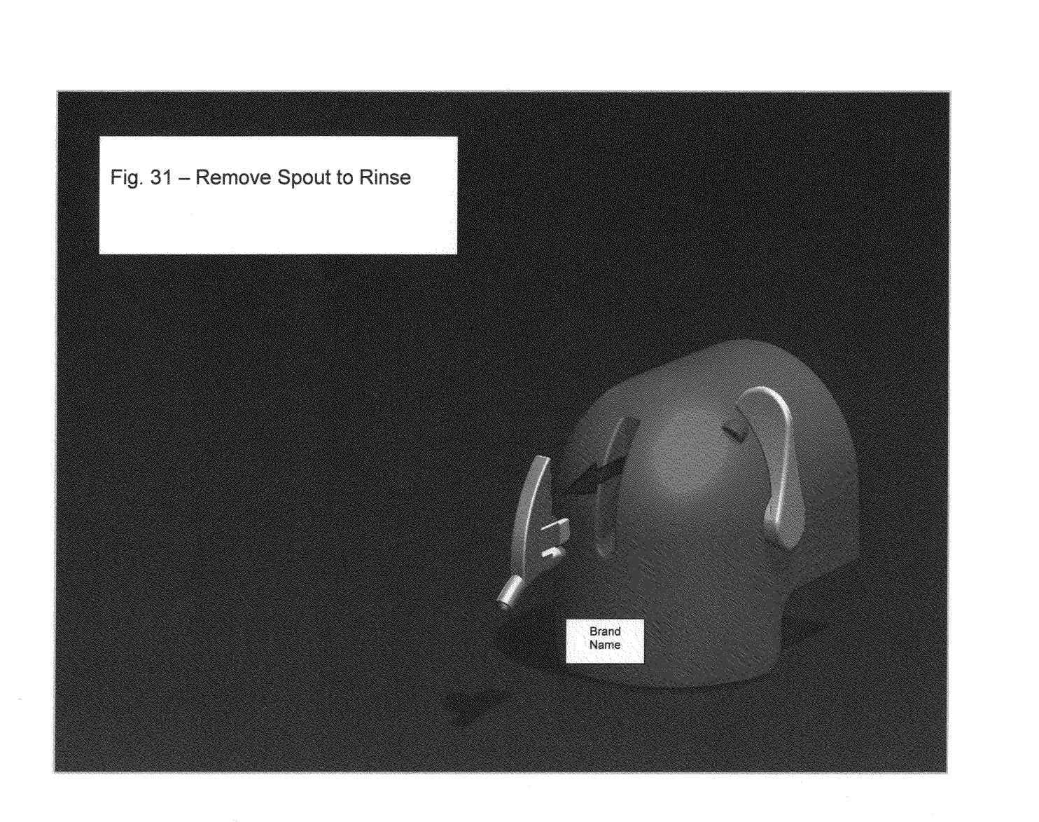

Now that the fluid connection between the spout and the dosing chamber has been closed, as shown in FIG. 31, the spout can be removed for cleaning prior to performing the next dispensing of the liquid, or at any other reasonable time interval, such as, for example, at least when the container is changed.

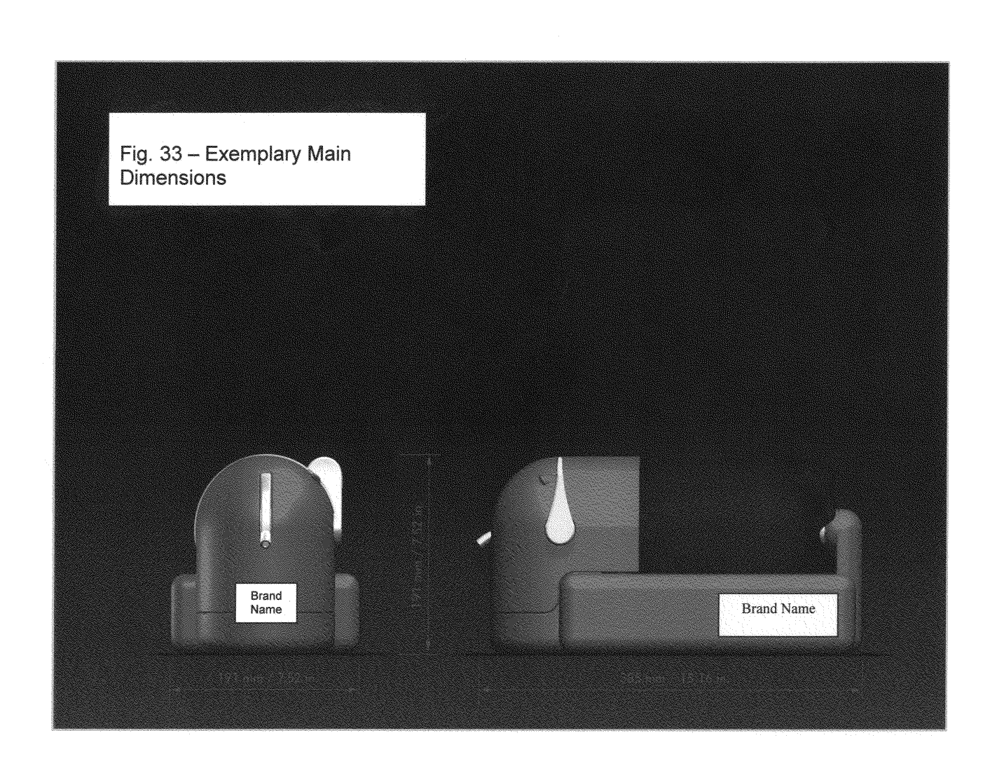

FIG. 32 depicts the main dispenser components of this exemplary embodiment. Finally, FIG. 33 depicts a side and front view of the exemplary embodiment, with exemplary illustrative dimensions. As shown in FIG. 32, in alternate exemplary embodiments, the device can have two rearward pistons, each sized to hold half the volume of water of the front piston. This balances the pressure load and also allows for a more optimal use of space. In such exemplary embodiments both pistons are connected to the front piston via the water circuit, and to the second inner container via the valve connector and the air circuit.

Thus, in exemplary embodiments of the present invention, a liquid is dispensed from a container under pressure to a small dosing chamber, also under pressure, actually under the same pressure. By this means any gas in the liquid remains in solution, inasmuch as when the pressure on each side of a liquid is equal the equilibrium pressure is never reached. As the liquid fills the dosing chamber the volume of the dosing chamber increases, but only enough so as to contain the liquid—as due to the applied pressure the dosing chamber bag never grows large enough to develop an inner air gap or bubble. By this means a liquid can be dispensed without losing any gas or gases dissolved in it. This works at any temperature, as long as there is an equalization of applied pressure to the container and to the dosing chamber, and that the applied pressure is high enough to hold the dissolved gas or gases in solution within the liquid.

The above-presented description and figures are intended by way of example only and is not intended to limit the present invention in any way except as set forth in the following claims. It is particularly noted that the persons skilled in the art can readily combine the various technical aspects of the various exemplary embodiments described.

What is claimed:

1. A method for dosed dispensing of a liquid from a container into a dispensing space, comprising:
dispensing the liquid in stages,
wherein the pressure on the liquid at each stage is maintained equal during transfer between a dispensing source and a dispensing destination via a pressure equalizing medium, and
wherein, in the container the liquid is provided in a first inner container and the equalizing medium is provided in a second inner container, wherein the first and second inner containers adjoin each other with a deformable and/or displaceable side between them.

2. The method of claim 1, wherein the liquid comprises a substance dissolved therein.

3. The method of claim 1, wherein the liquid is a carbonated liquid.

4. The method of claim 1, wherein the liquid comprises at least one of dissolved N₂O, laughing gas and nitrogen.

5. The method of claim 1, wherein in a first stage the pressure equalizing medium causes the volume of the second inner container to increase, thereby allowing the volume of the first inner container to decrease so as to displace the liquid out of the first inner container.

6. The method of claim 1, wherein said pressure equalization of the liquid in said stages occurs as follows:
in a first stage:
(i) a gas connection and then (ii) a liquid connection is brought about between the container and a dosing chamber,
the pressure in the container is equalized with the pressure in the dosing chamber by means of the gas connection, and
liquid flows from the container into the dosing chamber via the liquid connection; and
in a second stage:
(i) a gas connection and then (ii) a liquid connection is brought about between the dosing chamber and the dispensing space;
the pressure in the dosing chamber is equalized with the pressure in the dispensing space by means of the gas connection, and
the liquid in the dosing chamber is dispensed into the dispensing space via the liquid connection.

7. The method of claim 1, wherein the equalizing medium is one of air, a gas, a liquid, pressure from a piston or mechanical device and any combination thereof.

8. The method of claim 1, wherein an additional power source is connected to the container to pressurize the second inner container.

9. A device for dosed dispensing via a dispensing opening of a liquid received in a container,
wherein a difference in pressure between the container and the dispensing space is equalized in stages by introducing an equalizing medium from the container into an intermediate dosing chamber,
wherein the container comprises:
a first inner container in which the at least one liquid for dispensing can be received; and
a second inner container into which the equalizing medium can be introduced, and wherein the first and second inner containers adjoin each other at least with a deformable and/or displaceable surface.

10. The dispensing device of claim 9, wherein the liquid comprises a substance dissolved therein.

11. The dispensing device of claim 9, wherein the liquid comprises a solution of at least one of CO₂, N₂O, laughing gas, NO₂ and N₂.

12. The dispensing device of claim 9, wherein the pressure equalizing medium is at least one of air, a gas, a liquid, pressure from a piston or mechanical device and any combination thereof.

13. The dispensing device of claim 9, wherein the volume of the second inner container can be enlarged by introducing the pressure equalizing medium therein, and wherein as it is enlarged, the volume of the first container is reduced such that the liquid is displaced out of the first inner container without air gaps developing in said first inner container.

14. The dispensing device of claim 9, further comprising:
pressure equalizing means for equalizing the pressure of the liquid in stages,
said pressure equalizing means comprising:
a first closable gas conduit and first closable liquid conduit arranged between the container and a dosing chamber, individually closable with a first closing means; and
a second closable gas conduit and second closable liquid conduit arranged between the dosing chamber and the dispensing space, individually closable with second closing means,
wherein the first and second closing means are each adapted to open and close the liquid and gas passages in a desired sequence.

15. The dispensing device of claim 14, wherein the first and second closing means comprise recesses arranged in a movable part, and wherein said opening and closing of the liquid and gas passages in the desired sequence is performed by means of moving said movable part.

16. The dispensing device of claim 15, wherein the movable part is integrally manufactured.

17. The dispensing device of claim 9, further comprising an additional pressure source connected to the container and adapted to pressurize the second inner container.

18. The dispensing device of claim 14, wherein the dosing chamber is removably affixed.

19. The dispensing device of claim 9, wherein the container is situated at a higher level than the dispensing opening.

20. The dispensing device of claim 14, wherein the dosing chamber is at a height between that of the container and the dispensing opening.

21. The dispensing device of claim 9, wherein the method of claim 1 is performed.

22. The device of claim 9, wherein:
the liquid is a carbonated beverage;
the equalizing medium is a combination of air and water in pressure communication with each other;
the first inner container is an inner bag, the second inner container a space between the first inner container and an outer container shell; and
the container is provided horizontally in the device.

23. The device of claim 22, wherein the entire device can fit on a home refrigerator shelf.

24. The device of claim 22, wherein the entire device has a height no more than 191 mm and a length no longer than 385 mm.

25. The device of claim 22, further comprising:
a front piston, which moves along a vertical axis, having a water port;
two rear pistons, which move along a horizontal axis, each having an air port and a water port;
a valve connector connected to the second inner container;
an air circuit connecting the air port of each of the two pistons to the valve connector and to a pressure source; and
a water circuit connecting the water port of the front piston to the water ports of the two rear pistons.
